(19) United States
(12) Patent Application Publication
(10) Pub. No.: US 2026/0201118 A1
(43) Pub. Date: Jul. 16, 2026

(54) LATENT PREPOLYMERS AND USE AS CARBONIZATION INITIATORS AND FLAME RETARDANTS

(71) Applicant: CASE WESTERN RESERVE UNIVERSITY, Cleveland, OH (US)

(72) Inventors: Valentin Rodionov, Cleveland Heights, OH (US); Nathaniel Chapman, Berea, OH (US); Victor Desyatkin, Cleveland, OH (US)

(21) Appl. No.: 19/451,685

(22) Filed: Jan. 16, 2026

Related U.S. Application Data
(60) Provisional application No. 63/745,832, filed on Jan. 16, 2025.

(51) Int. Cl. C08G 69/28; C08J 7/04; C08J 7/05; C08L 23/00; C09D 5/18; C09D 177/06

(52) U.S. Cl. CPC C08G 69/28; C08J 7/0427; C08J 7/05; C08L 23/00; C09D 5/18; C09D 177/06; C08J 2323/00; C08J 2377/06; C08L 2201/02

(57) ABSTRACT

A method of forming a prepolymer with reactive groups capable of cycloadditions, the method includes interfacial polymerizing a diacid chloride monomer dissolved in an organic phase with a diamine monomer dissolved in an aqueous phase, wherein at least one of the diacid chloride monomer or the diamine monomer includes a reactive group capable of participating in a cycloaddition reaction, and the prepolymer is configured to undergo a cycloaddition reaction upon thermal, photochemical, or chemical activation, or any combination these activation methods.

### RELATED APPLICATION

This application claims priority from U.S. Provisional Application No. 63/745,832, filed Jan. 16, 2025, the subject matter of which is incorporated herein by reference in its entirety.

### BACKGROUND

Arynes are highly reactive intermediates that are commonly formed by 1,2-elimination of suitable ortho substituted benzenes. 1,2-elimination typically requires harsh alkaline conditions or complex precursors. In addition, unwanted byproducts are inherently generated. Recently, the Hexadehydro-Diels-Alder (HDDA) reactions have emerged as viable alternative atom-economical methods of forming arynes while having a low barrier to entry for suitable substrates. The reaction is a net [4+2]cycloaddition of tethered diyne and monoyne, typically with an atom spacer of 2-3 units. After formation, the aryne is quickly quenched (trapped). Careful selection of trapping agents can be employed to give structurally complex products via bond insertion or cycloadditions. Arynes have such a high reactivity, typical benign saturated C—H bonds of hydrocarbons have been reported to undergo direct dual C—H activation to form olefins.

Polyolefins have previously undergone stabilization by thermal oxidation and been subject of multiple studies, however the existing literature primarily addresses the degradation of mechanical performance and chemical properties of these materials. The existence of “ladder” structures in partially oxidized polyolefins and aromatization of the structures has been postulated. However, the precise molecular structures of those oxidatively stabilized intermediates, particularly at high extent of oxidation when the polymer is considered to have “degraded”, remain largely unexplored.

### SUMMARY

Embodiments described herein relate to methods of forming cycloaddition latent prepolymers, their use as carbonization initiators in the formation of carbonaceous materials, and particularly their use to enhance thermal stability and as flame-retardants for flammable polymers, such as polyolefins. We designed cycloaddition precursors or latent prepolymers capable of forming reactive aryne intermediates that can potentially crosslink and stabilize fully polyolefin feedstocks. The cycloaddition latent prepolymers described herein were found to be thermally robust with char yields up to 45% via thermal gravimetric analysis (TGA). These latent prepolymers were found to act as a “carbon seed” through various cycloaddition reactions, crosslinking the polyolefin and producing a more thermally robust material that can then undergo graphitization. Advantageously, cycloaddition latent prepolymers described herein were found to act as flame drip suppressors when coated on a polyolefin substrate, forming stable char, acting as a thermal shield, reducing flame drips, and acting as a radical sponge, further increasing flame retardancy of the polyolefin during flammability tests.

In some embodiments, a method of forming a latent prepolymer with reactive groups capable of cycloadditions includes interfacial polymerizing a diacid chloride monomer dissolved in an organic phase with a diamine monomer dissolved in an aqueous phase to form the latent prepolymer. At least one of the diacid chloride monomer or the diamine monomer includes a reactive group capable of participating in a cycloaddition reaction, and the latent prepolymer is configured to undergo a cycloaddition reaction upon thermal, photochemical, or chemical activation, or any combination these activation methods.

In some embodiments, a first mixture comprising the diacid chloride monomer dissolved in the organic phase and a second mixture comprising the diamine monomer and an optional auxiliary base dissolved in the aqueous phase are added together, and the latent prepolymer is formed at an interface between the first mixture and the second mixture.

In some embodiments, the latent prepolymer is a polyamide that includes a plurality of reactive groups capable of participating in the cycloaddition reaction.

In some embodiments, at least one of the diacid chloride monomer or the diamine monomer includes at least one of a monoyne, diyne, ene, or aromatic reactive group.

In some embodiments, the latent prepolymer is a polyamide containing at least one diyne reactive group that is configured to undergo a dehydrogenerative-Diels-Alder (DDA) reaction upon thermal, photochemical, or chemical activation, or any combination of these activation methods.

In some embodiments, the latent prepolymer has a char yield of at least 31% upon thermal gravimetric analysis (TGA) from 30° C. to 1000° C., with a heating ramp of 10° C./min in an inert atmosphere.

In other embodiments, the latent prepolymer includes a structure or repeating unit selected from:

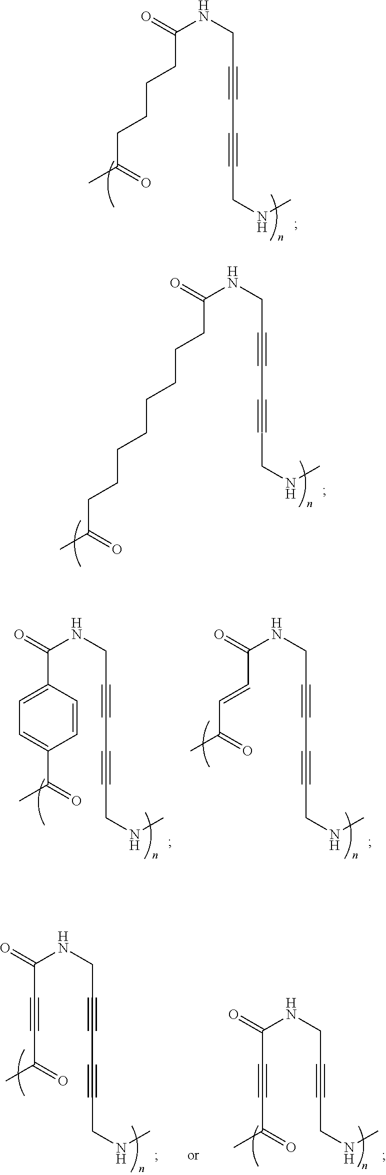

wherein n is an integer greater than 10.

Other embodiments described herein relate to a cycloaddition latent prepolymer formed by a method described herein.

Still other embodiments relate to a char-forming or flame-retardant coating or additive comprising a cycloaddition latent prepolymer as described herein.

Other embodiments described herein relate to a flame-retardant polyolefin construct that includes a polyolefin combined with a latent prepolymer. The latent prepolymer includes at least one reactive group capable of participating in a cycloaddition reaction and is configured to undergo a cycloaddition reaction upon thermal, photochemical, or chemical activation, or any combination of these activation methods.

In some embodiments, the latent prepolymer is a polyamide that includes a plurality of reactive groups capable of participating in the cycloaddition reaction.

In some embodiments, the latent prepolymer is formed by interfacial polymerization of a diacid chloride monomer with a diamine monomer, and at least one of the diacid chloride monomer or a diamine monomer includes at least one of a monoyne, diyne, ene, or aromatic reactive group.

In some embodiments, the latent prepolymer is a polyamide containing reactive groups that are configured to undergo a dehydrogenative Diels-Alder (DDA) reaction upon thermal, photochemical, or chemical activation, or any combination of these activation methods.

In other embodiments, at least one of the diacid chloride monomer or the diamine monomer includes a diyne group, and the latent prepolymer is configured to undergo a hexadehydro-Diels-Alder (HDDA) reaction upon thermal, photochemical, or chemical activation, or any combination of these activation methods.

In some embodiments, the latent prepolymer, which is combined with the polyolefin, includes a structure or repeating unit selected from:

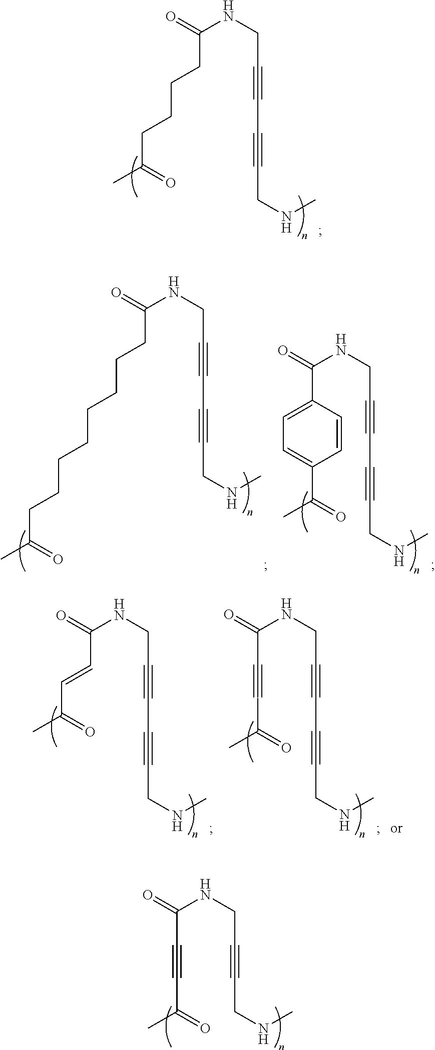

wherein n is an integer greater than 10.

In some embodiments, the latent prepolymer, which is combined with the polyolefin, has a char yield of at least 31% upon thermal gravimetric analysis (TGA) from 30° C. to 1000° C., with a heating ramp of 10° C./min in an inert atmosphere.

In some embodiments, the polyolefin can include a low-density polyethylene, a linear low-density polyethylene, a high-density polyethylene, or polypropylene.

In some embodiments, the flame-retardant polyolefin construct includes a mixture or composite of the latent prepolymer and the polyolefin.

In some embodiments, the mixture or composite of the latent prepolymer and the polyolefin is oxidized.

In other embodiments, the flame-retardant polyolefin construct can include a polyolefin substrate at least partially coated with the latent prepolymer.

### BRIEF DESCRIPTION OF THE DRAWINGS

FIG. 1 illustrates a schematic showing diffusion of diamine and formation of oligomers.

FIG. 2 illustrates an image showing interfacial polymerization of PHDA.

FIG. 3 illustrates a chart showing synthesis and reactivity of DDA-latent prepolymers.

FIGS. 4(A-B) illustrate TGA plots of Alkyl-tethered Derivatives, PHDA, PHDS, and PHBY 30-1000° C. @10° C./min under nitrogen (A). Derivative of TGA plot with extrema droplines (B).

FIGS. 5(A-B) illustrate TGA plots of Alkynyl-tethered Derivatives, PHDBY and PBBY 30-1000° C. @10° C./min under nitrogen (A). Derivative of TGA plot with extrema droplines (B).

FIGS. 6(A-B) illustrate TGA plots of Alkenyl and Phenyl Tethered Derivatives, PHDF and PHDT 30-1000° C. @10° C./min under nitrogen (A). Derivative of TGA plot with extrema droplines (B).

FIGS. 7(A-B) illustrate plots showing DSC heating scan of Prepared DDA-prepolymers from 30-1000° C. @10° C./min under nitrogen.

FIG. 8 illustrates plots showing second Heating Scan of DDA-latent Prepolymers.

FIG. 9 illustrates a schematic of a thermal separation probe.

FIG. 10 illustrates mass spectrometry (MS) of poly((hexa-1,4-diynyl)-fumaramide), PHDF (TSP-MS) at Various Temperatures.

FIG. 11 illustrates FTIR of thermally treated PHDF at various heat treatments under inert atmosphere (ATR-FTIR on germanium).

FIG. 12 illustrates a schematic of a bulk carbonization experimental setup.

FIG. 13 illustrates a Raman spectrum of PHDF carbon.

FIG. 14 illustrates a survey XPS of PHDF carbon.

FIG. 15 illustrates a high-res XPS of PHDF carbon.

FIG. 16 illustrates a photo of PHDF Carbon at 1000° C.

FIGS. 17(A-B) illustrates schemes of (A) DDA-latent prepolymers and respective reactive intermediates; and (B) proposed thermal crosslinking of polyolefins via reactive intermediates.

FIG. 18 illustrates a schematic of carbonization of LDPE by DDA-latent prepolymers.

FIG. 19 illustrates an FTIR of Thermally Oxidized PHDA and LDPE Mixtures.

FIG. 20 illustrates a thermogram of thermally oxidized DDA-prepolymer LDPE Mixtures.

FIG. 21 illustrates Raman Spectra of PHDA/LDPE [Ox.] Heat Treated at 1000° C.

FIG. 22 illustrates an image of 1.5 mm PHDA Coating on 127 mm×127 mm LDPE Substrates.

FIG. 23 illustrates a chart showing burn tests of PHDA-coated LDPE and Virgin LDPE.

FIG. 24 illustrates a schematic hypothesized Flame Drip Suppression of LDPE.

### DETAILED DESCRIPTION

All scientific and technical terms used in this application have meanings commonly used in the art unless otherwise specified. The definitions provided herein are to facilitate understanding of certain terms used frequently herein and are not meant to limit the scope of the application.

The articles “a” and “an” are used herein to refer to one or to more than one (i.e., to at least one) of the grammatical object of the article. By way of example, “an element” means one element or more than one element.

As used herein, the verb “comprise” as is used in this description and in the claims and its conjugations are used in its non-limiting sense to mean that items following the word are included, but items not specifically mentioned are not excluded. The present invention may suitably “comprise”, “consist of”, or “consist essentially of”, the steps, elements, and/or reagents described in the claims.

Throughout the description, where compositions are described as having, including, or comprising, specific components, it is contemplated that compositions also consist essentially of, or consist of, the recited components. Similarly, where methods or processes are described as having, including, or comprising specific process steps, the processes also consist essentially of, or consist of, the recited processing steps. Further, it should be understood that the order of steps or order for performing certain actions is immaterial so long as the compositions and methods described herein remains operable. Moreover, two or more steps or actions can be conducted simultaneously.

The term “A and/or B” means “A or B, or A and B”.

As used herein, the term “about” or “approximately” refers to a quantity, level, value, number, frequency, percentage, dimension, size, amount, weight or length that varies by as much as 15%, 10%, 9%, 8%, 7%, 6%, 5%, 4%, 3%, 2% or 1% to a reference quantity, level, value, number, frequency, percentage, dimension, size, amount, weight or length. In one embodiment, the term “about” or “approximately” refers a range of quantity, level, value, number, frequency, percentage, dimension, size, amount, weight or length ±15%, ±10%, ±9%, ±8%, ±7%, ±6%, ±5%, ±4%, ±3%, ±2%, or ±1% about a reference quantity, level, value, number, frequency, percentage, dimension, size, amount, weight or length.

Throughout this disclosure, various aspects of this invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual and partial numbers within that range, for example, 1, 2, 3, 4, 5, 5.5 and 6. This applies regardless of the breadth of the range.

Embodiments described herein relate to methods of forming cycloaddition latent prepolymers, their use as carbonization initiators in the formation of carbonaceous materials, and particularly their use to enhance thermal stability and as flame-retardants for flammable polymers, such as polyolefins. We designed cycloaddition precursors or latent prepolymers capable of forming reactive aryne intermediates that can potentially crosslink and stabilize fully polyolefin feedstocks. The cycloaddition latent prepolymers described herein were found to be thermally robust with char yields up to 45% via thermal gravimetric analysis (TGA). These latent prepolymers were found to act as a “carbon seed” through various cycloaddition reactions, crosslinking the polyolefin and producing a more thermally robust material that can then undergo graphitization. Advantageously, cycloaddition latent prepolymers described herein were found to act as flame drip suppressors when coated on a polyolefin substrate, forming stable char, acting as a thermal shield, reducing flame drips, and acting as a radical sponge, further increasing flame retardancy of the polyolefin during flammability tests.

In some embodiments, a method of forming a latent prepolymer with functional groups capable of cycloadditions includes interfacial polymerizing a diacid chloride monomer dissolved in an organic phase with a diamine monomer dissolved in an aqueous phase to form the latent prepolymer under the absence of light and at moderate thermal conditions, such as room temperature. At least one of the diacid chloride monomer or the diamine monomer includes a reactive group capable of participating in a cycloaddition reaction, and the latent prepolymer is configured to undergo a cycloaddition reaction upon thermal, photochemical, or chemical activation, or any combination these activation methods.

In some embodiments, the diacid chloride monomer that includes a cycloaddition reactive group can include a structure having the general formula:

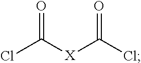

where X includes at least one of a monoyne, diyne, ene, or aromatic group.

In some embodiments, the diacid chloride monomers that include a cycloaddition reactive group, can be prepared under moderate conditions, have a length upon polymerization with the diamine monomer effective to react intramolecularly to yield reactive arynes, are soluble in the organic phase, and can readily form polyamides with the diamine monomers.

Examples of diacid chloride monomers that include a cycloaddition reactive group, can be prepared under moderate conditions, have a length upon polymerization with the diamine monomer effective to react intramolecularly to yield reactive arynes, are soluble in the organic phase, and can readily form polyamides with the diamine monomers include, for example,

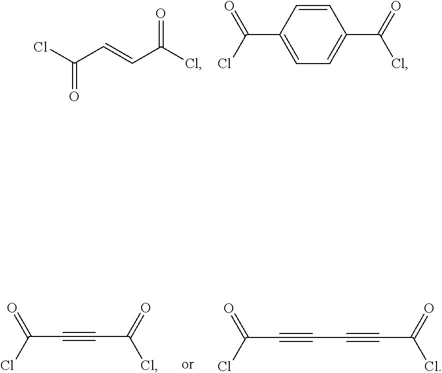

In other embodiments, a diacid chloride monomer that does not include a cycloaddition reaction group but can be prepared under moderate conditions, has a length upon polymerization with a reactive group containing diamine monomer effective to react intramolecularly to yield reactive arynes, are soluble in the organic phase, and can readily form polyamides with the diamine monomer can include, for example,

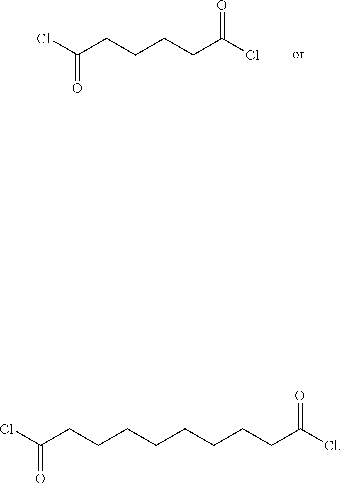 [SMILES: O=C(Cl)CCCCC(=O)Cl ; "or" ; O=C(Cl)CCCCCCCCC(=O)Cl]

The organic phase in which the diacid chloride monomer is dissolved can include, for example, cyclohexane, toluene, or methylene chloride.

In some embodiments, the diamine monomer that includes a cycloaddition reactive group can include a structure having the general formula:

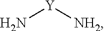

where Y includes at least one of a monoyne, diyne, ene, or aromatic group.

In some embodiments, the diamine monomers that include a cycloaddition reactive group can be prepared under moderate conditions, have a length upon polymerization with the diacid chloride monomers effective to react intramolecularly to yield reactive arynes, are soluble in an aqueous phase, and can readily form polyamides with the diacid chloride monomers.

Examples of diamine monomers that include a cycloaddition reactive group, can be prepared under moderate conditions, have a length upon polymerization with the diacid chloride monomers effective to react intramolecularly to yield reactive arynes, are soluble in an aqueous phase, an can readily form polyamides with the diacid chloride monomers include for example

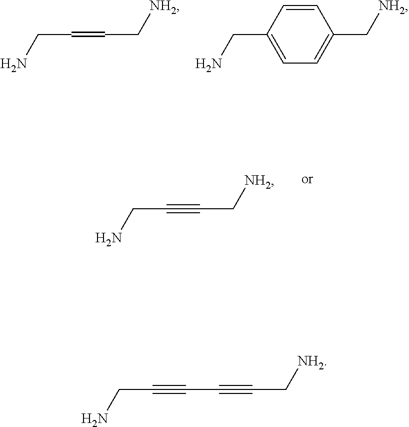 [SMILES: NCC=CCN ; NCc1ccc(CN)cc1 ; NCC#CCN ; "or" ; NCC#CC#CCN]

In other embodiments, a diamine monomer that does not include a cycloaddition reaction group but can be prepared under moderate conditions, has length upon polymerization with a reactive group containing diacid chloride monomer effective to react intramolecularly to yield reactive arynes, is soluble in the organic phase, and can readily form polyamides with the diacid chloride monomer, can include, for example,

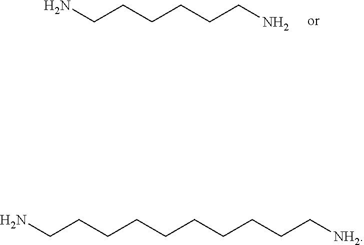 [SMILES: NCCCCCCN ; NCCCCCCCCCCN]

In some embodiments, a first mixture that includes the diacid chloride monomer dissolved in the organic phase and a second mixture that includes the diamine monomer dissolved in the aqueous phase can be prepared. The denser of the first mixture or second mixture can be initially added to a container, such as a beaker. The less-dense mixture can then be added to the container to form a biphasic solution with a liquid/liquid interphase separating the organic phase and aqueous phase. As the monomers in the less dense overlying mixture diffuse to the denser mixture, a reaction zone is created as the amine groups of the diamine monomers react with the carbonyl groups of diacid chloride monomers as shown in Scheme 1 below. After the formation of the amide, HCl is formed as a byproduct and forms a salt with unreacted diamine monomers. The ammonium salt is then readily converted back by deprotonation from the addition of an inorganic base, such as KOH.

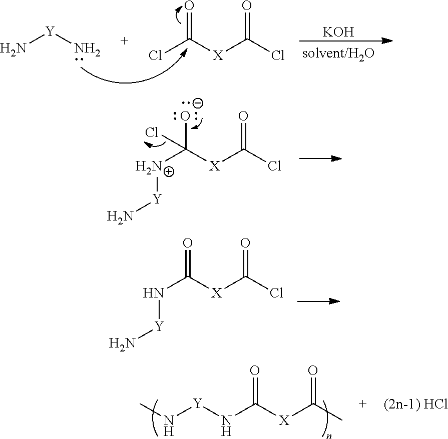

After a sufficient number of sequential reactions, oligomers and polymers begin to form near the interface of the biphasic solution. Once a dense barrier is formed, the diffusion of the monomers is hindered, which decelerates film formation. At a high enough molecular weight, the interfacial polymerized prepolymers can be drawn into a rope and collected. While drawn, the dense barrier layer is removed, allowing the prepolymer to form with ease at the interface until the removal of either monomer or solvent phase.

The collected prepolymer can then be washed with, for example, water, methanol, and/or acetone, filtered after each wash, and dried.

In some embodiments, the latent prepolymer formed by interfacial polymerization using the diacid chloride monomers and diamine monomers described herein can include repeat units or a structure selected from:

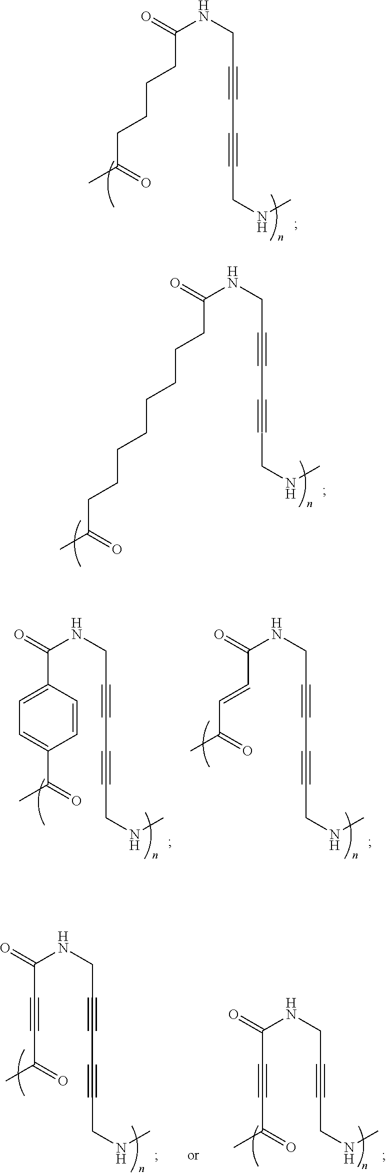

wherein n is an integer greater than 10, or n is greater than 100, e.g., n is about 10 to about 1000, including any range therebetween.

The latent prepolymers so formed can undergo an intramolecular or intermolecular cycloaddition reaction upon thermal, photochemical, or chemical activation, or any combination these activation methods. The cycloaddition reaction can include a Diels-Alder reaction, preferably a dehydrogenative-Diels-Alder (DDA) reaction, between intramolecular or intermolecular reactive groups, e.g., monoyne, diyne, ene, or aromatic group, of the latent prepolymers. The spacing between the DDA reactive groups of the prepolymer can affect the cycloaddition reactions. At shorter spacing between DDA reactive groups, intramolecular reactions dominate. As spacing increases as result of selecting a monomer that does not include a DDA reactive group, such as an aliphatic monomer, intermolecular reactions become dominant. Advantageously, the latent prepolymer includes alkyne groups in sufficient proximity of the repeat unit to undergo a hexahydro-Diels-Alder reaction, yielding reacting benzynes, which can undergo further cycloaddition reactions, e.g., cascade cycloaddition reactions, intramolecularly or intermolecularly with other polymers.

In some embodiments, the latent prepolymer so formed has a char yield of at least about 31% upon thermal gravimetric analysis (TGA) from 30° C. to 1000° C., with a heating ramp of 10° C./min in an inert atmosphere, preferably at least about 34% upon thermal gravimetric analysis (TGA) from 30° C. to 1000° C., with a heating ramp of 10° C./min in an inert atmosphere. By “char yield” it is meant the fraction, e.g., wt. %, of a polymer that remains as solid carbide or carbonaceous residue after thermal decomposition under an inert atmosphere. It was found that by removing DDA activity of the latent prepolymers by, for example, increasing spacing between the DDA reactive groups, Char yield for the latent prepolymers decreases and intermolecular reactivity increases, resulting in a higher sp² content. Increasing DDA activity in the latent prepolymers by, for example, decreasing spacing of the DDA reactive group, increases the sp³ content and sp²/sp³ ratio providing a higher char yield.

Still other embodiments relate to a char-forming or flame-retardant coating or additive that includes a cycloaddition latent prepolymer as described herein. The latent prepolymers described herein can be mixed at a low loading with a flammable polymer, such as polyolefin, and optionally in conjunction with thermal oxidation, generate reactive intermediates that can crosslink the polyolefin and produce a more thermally robust material that can then undergo graphitization.

The latent prepolymer can be applied to at least one flammable polymer, such as a polyolefin, by mixing the latent prepolymer with flammable polymer or coating a polymer substrate with the latent prepolymer. For example, the flammable polymer may be a polymer waste comprising or consisting of polyolefin, such as a low-density polyethylene, high-density polyethylene, polypropylene, or any combination thereof, and the latent prepolymer can be mixed with or coated on the polymer substrate. In more detail, the latent prepolymer can be applied to all agricultural, industrial, and household olefin-based polymers including all olefin-based polymer wastes containing plasticizers, dyes, and the like.

In some embodiments, the latent prepolymer can be mixed with the flammable polymer at a concentration of about 1% by weight to about 50% by weight, for example, about 1% by weight to about 45% by weight, about 1% by weight to about 40% by weight, about 1% by weight to about 35% by weight, about 1% by weight to about 30% by weight, about 1% by weight to about 25% by weight, about 1% by weight to about 20% by weight, about 1% by weight to about 15% by weight, or about 1% by weight to about 10% by weight, including ranges between any of the foregoing values.

The mixture of latent prepolymer and flammable polymer, such as a polyolefin, can optionally be thermally oxidized by heating the mixture in the presence of oxygen, e.g., air, at an elevated temperature to generate reactive intermediates that can crosslink the flammable polymer and produce a more thermally robust material that can then undergo graphitization. For example, a mixture of a ground polyolefin, such as low density polyethylene, and a latent prepolymer described herein, can be heated from about 250° C. to about 275° C., e.g., about 270° C., while exposed to air for a duration of time effective to produce a more thermally robust material that can then undergo graphitization.

Other embodiments described herein relate to a flame-retardant polyolefin construct that includes a polyolefin combined with a latent prepolymer as described herein.

In some embodiments, the polyolefin can include a α-C2 to 20 chain olefin resin or a cyclic olefin resin. Examples of the α-C2 to 20 chain olefin resin include a polyethylene resin (High Density Polyethylene [HDPE], Low Density Polyethylene [LDPE], Linear Low Density Polyethylene [LLDPE], Very Low Density Polyethylene and Ultra Low Density Polyethylene [VLDPE, ULDPE], etc.), a polypropylene resin, and a methyl pentene resin.

These polyolefins can be used alone or in combinations of two or more. In one embodiment, the polyolefin is a polypropylene resin, HDPE, or LPDE.

In some embodiments, the polypropylene resin may be a homopolymer of propylene, or may be a copolymer of propylene and another copolymerizable monomer. Other copolymerizable monomers include, for example: olefin monomers, such as a α-C2 to 20 chain olefin exemplified by ethylene, 1-butene, isobutene, 1-pentene, 4-methyl-1-pentene, and cyclic olefins; vinyl ester-based monomers, such as vinyl acetate and vinyl propionate; (meth)acrylic monomers, for example, (meth)acrylic acid, alkyl (meth)acrylate, vinyl cyanide monomers such as (meth)acrylonitrile; diene monomers such as butadiene; unsaturated polyvalent carboxylic acids or acid anhydrides thereof, such as maleic acid, itaconic acid, citraconic acid or acid anhydrides thereof, imide-based monomers, for example, maleimide and N-substituted maleimides exemplified by N-alkylmaleimides such as N—C1 to 4 alkylmaleimides. These copolymerizable monomers may be used alone or in a combination of two or more.

In some embodiments, the flame-retardant polyolefin construct includes a polyolefin substrate that is coated with the latent prepolymer described herein. The latent prepolymer can function as a flame drip suppressor by forming a stable char upon ignition of the construct that can act as a thermal shield to reduce flame drips. Additionally, upon ignition of the construct, the latent prepolymer can undergo a cycloaddition reaction that generates diradical flame-retardant intermediates that can act as radical sponge to further increase the flame retardancy and suppress flame drips. Advantageously, it was found that compared to an uncoated polyolefin substrate, polyolefin substrates coated with the latent prepolymers described herein took on average twice as long to initiate the high flow of flaming drips and underwent this behavior for three times less time. Additionally, the average total burn time was found to be twice as long as uncoated substrates.

In other embodiments, the flame-retardant polyolefin construct can include a composite of the latent prepolymer described herein and the polyolefin, where the latent prepolymer is incorporated in polyolefin matrix The latent prepolymer described herein when provided in polyolefin matrix can undergo a cycloaddition reaction, resulting in an increase of intermolecular interactions, and potentially act as a radical sponge, allowing the composite to char continuously and further suppress the flame drips upon ignition of the composite.

In some embodiments, the latent prepolymer can be provided in the composite at a concentration of about 1% by weight to about 70% by weight, for example, about 1% by weight to about 65% by weight, about 1% by weight to about 60% by weight, about 1% by weight to about 55% by weight, about 1% by weight to about 50% by weight, about 1% by weight to about 45% by weight, about 1% by weight to about 40% by weight, about 1% by weight to about 35% by weight, or about 1% by weight to about 30% by weight, about 1% by weight to about 25% by weight, about 1% by weight to about 20% by weight, about 1% by weight to about 15% by weight, about 1% by weight to about 10% by weight, or about 1% by weight to about 5% by weight, including ranges between any of the foregoing values.

The invention is further illustrated by the following examples, which is not intended to limit the scope of the claims.

### EXAMPLE

### Materials and Methods

### Materials

All reagents and solvents were acquired from commercial suppliers (Acros Organics, Sigma-Adrich, TCI Chemicals, Fisher Scientific, Oakwood Chemical and VWR International) and used without further purification, unless otherwise noted. Tetrahydrofuran (THF) was distilled over Na/benzophenone.

### Synthetic Methods

Reactions were monitored by thin-layer chromatography (TLC) carried out on 0.25 mm MilliporeSigma aluminum-backed silica gel plates (60F-254). Plates were visualized using 254 nm UV light and basic potassium permanganate stain (1.5 g KMnO4, 0.5 g NaOH, and 10 g K2CO3 in 150 mL water; terminal alkynes stain yellow). Flash chromatography was performed on Luknova SuperSep™ (230-400 mesh) silica gel. Reactions requiring anhydrous or air-free conditions were performed under positive pressure of N2 or Ar using standard Schlenk line techniques.

### Nuclear Magnetic Resonance (NMR) Spectrometry

NMR spectra were recorded on a Bruker Avance III HD 500 spectrometer operating at 500.24 (¹H), or 125.79 (¹³C) MHz and equipped with Bruker Ascend 500 MHz US Narrow Bore Magnet and Broadband Prodigy TCI CryoProbe. NMR spectra were referenced to TMS (¹H, ¹³C) or residual solvent peaks. Chemical shifts (6) are reported in parts per million (ppm).

### Gas Chromatography-Mass Spectrometry

GC-MS analyses were performed on an Agilent 5977B GC/MSD instrument equipped with an Agilent 7890B automatic liquid sampler and a thermal separation probe. Before injection of dissolved samples, the 10 μL syringe was cleaned with acetone and ethyl acetate (3×10 μL each). 1 μL of the sample was then automatically injected into the instrument. The method used a 3-minute solvent delay. The oven was initially set at 60° C. and held at this temperature for 2.25 minutes before increasing the temperature to 225° C. at 35° C./min rate. Before injection of solid samples via a thermal separation probe, the inlet temperature was set to either 150° C., 250° C., or 400° C. and data was collected for 3 min. Data analysis was performed using Agilent MassHunter Qualitative Analysis Navigator.

### Infrared Spectroscopy

Routine small molecule FTIR spectra were collected on an Agilent Cary 630 FTIR instrument equipped with a single-reflection germanium attenuated total reflectance (ATR) module. The instrument was calibrated before sampling against a newly cleaned (acetone) and dried crystal surface. Solid samples were placed directly on the crystal and secured with a needle press. 32 scans from 4000 to 550 cm⁻¹ were recorded. A background was collected for each sample (512 scans).

Fourier transform infrared spectroscopy (FTIR) spectra was recorded using an ABB MB3000 FTIR spectrometer, which is equipped with a deuterated triglycine sulfate (DTGS) detector and a dry air purge unit. Co-addition of 32 scans was carried out at a resolution of 4 cm⁻¹ in the frequency range of 4000-400 cm⁻¹. All samples were ground with potassium bromide powder and pressed into a disk, and the spectrum was recorded in the absorbance mode.

### Raman Spectroscopy

Micro-Raman scattering spectra were recorded using a Horiba Jobin Yvon LabRam HR800 spectrometer at room temperature connected to a cooled charge coupled device detector using an 1800 lines per mm grating. A helium-neon (HeNe) laser (λ=632.8 nm) was focused on the surface of a sample at an optical power of 17 mW using an Olympus optical microscope. The Raman frequency was calibrated with a silicon wafer using the 520 cm⁻¹ line and analyzed using CasaXPS software.

### Melting Points

Melting points were determined with a Mettler Toledo MP50 Melting Point System.

### Thermal Gravimetric Analysis (TGA)

The thermal stability of the prepared polymers was carried out by using a TA Instruments Q500 TGA. 1.0 mg of the sample was loaded on a Pt pan and underwent heating from 30-1000° C. at a heat ramp of 10° C./min using nitrogen as the purge gas at a flowrate of 40 mL/min.

### Differential Scanning Calorimetry (DSC)

Differential scanning calorimetry (DSC) study was conducted using a TA Instruments DSC model 2920 with a heating rate of 10° C./min and a nitrogen flow rate of 60 mL/min. 1 mg of the prepared polymer was charged to a hermetically sealed aluminum pan and underwent two heating cycles from 40° C. to the temperature at 5% mass degradation (T5%).

### Thermal Treatment

Each polymer was subjected to heat treatment at 15° C./min and held at the setpoint for 20 min in LINDBERG/BLUE mini-mite furnace model no. TF55030A under an argon atmosphere to prepare carbonaceous samples.

### X-Ray Photoelectron Spectroscopy (XPS)

Samples were spread onto double-sided copper tape for XPS analysis. Surveys and high-resolution spectra were acquired on a PHI VersaProbe II Scanning XPS Microprobe using a monochromatic Al X-ray at pressures of 10⁻¹⁰ to 10⁻⁷ Torr. The data was smoothed by using the Savitzky-Golay method, with a smoothing width of five, and analyzed using CasaXPS software.

A Shirley background was applied to each peak before deconvolution. All peak fits used generalized Voigt-like peak shapes, as this function is most appropriate for fitting asymmetric XPS signals. CasaXPS provides a generalized Voigt function described as Lorentzian Finite: LF(α, β, w, n, m), where the first three parameters (α, β, w) affect the Lorentzian line shape and its asymmetry and the final two (n, m) change the width of the Gaussian function and the number of times convolution with the Lorentzian component occurs. Symmetrical peak parameters for the LF line shape were used: LF(1, 1, 255, 360, 6), values derived from default symmetric peak shape settings for CasaXPS. Asymmetric peak parameters for LF line shape for the sp² peak were LF(0.6, 1, 355, 360, 6). All sub-peak widths were constrained to full width at half maximum (FWHM) of 1.6 eV or less. The subpeaks are located at 284.4 eV (aromatic sp²), 285.4 eV (aromatic sp³), 287.5 eV (carbonyl/ether C═O/C—O), and 289.5 eV (ester/carboxylic acid O—C═O). All peaks were allowed a 0.2 eV padding to the peak position.

### Small Molecule Synthesis

### Hexa-2,4-diyne-1,6-diol

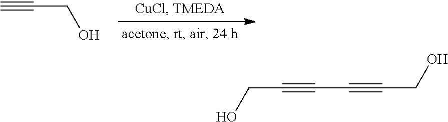

To a 500 mL beaker charged with CuCl (2.57 g, 25.9 mmol) was added N,N,N′,N′-tetramethylethane-1,2-diamine (TMEDA; 3.9 mL, 25.9 mmol) and 300 mL acetone and was allowed to stir for 30 min while being exposed to air. Propargyl alcohol (30.0 mL, 173 mmol) was then added to the mixture and was allowed to stir at room temperature for 24 h with continual exposure to air. The solution was passed through a neutral alumina column (monitored via TLC) using acetone as the eluent for removal of copper species. Removal of the liquid under reduced pressure yielded the product was an off-white solid (2.5 g, 88% yield). MP=111.3-112.3° C. ¹H NMR (500 MHz, DMSO-d6) δ 5.39 (s, 2H), 4.17 (s, 4H). ¹³C NMR (126 MHz, CDCl3) δ 79.61, 67.99, 49.40. FTIR (KBr) vmax=3275.8, 2929.2, 2690.8, 2443.7, 2178.6, 2126, 2018, 1473.5, 1347.8, 1219, 1007.2, 913.67, 670.99 cm⁻¹.

### 1,6-diphthalimido-2,4-hexadiyne

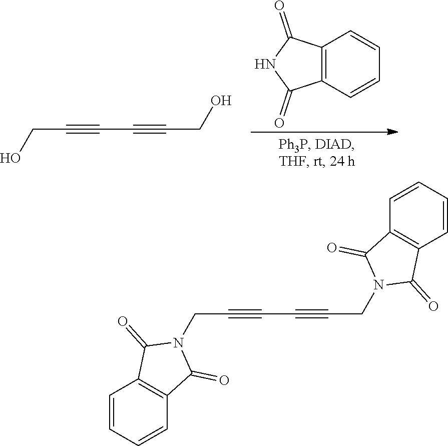 [SMILES: OCC#CC#CCO ; O=C1NC(=O)c2ccccc21 ; O=C1c2ccccc2C(=O)N1CC#CC#CCN1C(=O)c2ccccc2C1=O]

To a 1000 mL three-neck RBF containing a mixture of hexa-2,4-diyne-1,6-diol (24 g, 215 mmol), triphenylphosphine (116 g, 441 mmol), and phthalimide (65 g, 440 mmol) in dry THF (500 mL) under argon was slowly added diisopropylazodicarboxylate (DIAD; 89 g, 460 mmol) at 0° C. via an addition funnel. The solution was then allowed to stir under N2 for 24 h while heating to room temperature. The mixture was filtered and the resulting residue was washed with excess amounts of THF and collected to yield the final product as a white powder (63.3 g, 80% yield). The product decomposes into a brown solid at 228-233° C. and does not melt. ¹H NMR (500 MHz, CDCl3) δ 7.86 (dd, J=5.2, 3.1 Hz, 4H), 7.73 (dd, J=5.3, 3.1 Hz, 4H), 4.49 (s, 4H). ¹³C NMR (126 MHz, CDCl3) δ 166.13, 134.67, 132.30, 124.03, 72.49, 67.76, 27.94. FTIR (neat) vmax=2948.5, 2369.1, 2344.1, 1768.8, 1714.6, 1610.4, 1466.2, 1390.3, 1339.1, 1188.7, 1114.8, 1003.2, 940.3, 841.3, 797.09, 723.2 cm⁻¹.

### Hexa-2,4-diyne-1,6-diamine

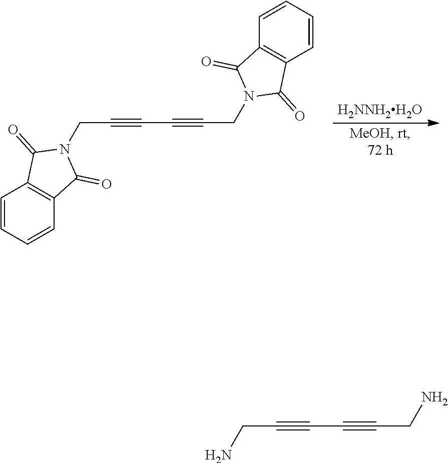 [SMILES: O=C1c2ccccc2C(=O)N1CC#CC#CCN1C(=O)c2ccccc2C1=O ; "H2NNH2·H2O" ; "MeOH, rt,72 h" ; NCC#CC#CCN]

To a 1000 mL RBF containing a mixture of 1,6-diphthalimido-2,4-hexadiyne (5.0 g, 13.6 mmol) stirred in 500 mL methanol was added hydrazine monohydrate (12.5 mL, 256 mmol) and was allowed to stir at room temperature for 72 h under argon in the absence of light. 250 mL of methanol was added to the mixture and then was filtered. The filtrate was concentrated under reduced pressure to afford the crude product as an off-white solid. The crude product was then extracted with 150 mL of methylene chloride, shaken with anhydrous sodium sulfate, and filtered. Removal of the solvent yielded the product as an off-white solid, which was stored at −30° C. in an amber vial (1.1 g, 75% yield). ¹H NMR (500 MHz, DMSO-d6) δ 3.34 (s, 4H), 2.21 (br, 4H). ¹³C NMR (126 MHz, DMSO-d6) δ 80.82, 66.06, 31.17. FTIR (KBr) vmax=3344.3, 3313.5, 3259.5, 2916.2, 2840.9, 2252.7, 2142.8, 1716.5, 1577.7, 1477.4, 1433.0, 1373.2, 1328.9, 1182.3, 1120.6, 1076.2, 960.5, 871.8, 723.3, 696.3, 605.6, 543.9 cm⁻¹.

### 2,2′-(but-2-yne-1,4-diyl)bis(isoindoline-1,3-dione)

To a 250 mL three-neck RBF containing a mixture of but-2-yne-1,4-diol (5.0 g, 58.1 mmol), triphenylphosphine (31.2 g, 119 mmol), and phthalimide (17.5 g, 119 mmol) in dry THF (100 mL) under argon was slowly added diisopropylazodicarboxylate (DIAD; 24.1 g, 119 mmol) at 0° C. via an addition funnel. The solution was then allowed to stir for 30 h while heating to room temperature. The mixture was filtered and the resulting residue was washed with excess amounts of THF and collected to yield the final product as a white solid (18.5 g, 92% yield). The product decomposes into a brown solid around 225° C. and does not melt. ¹H NMR (500 MHz, CDCl3) δ 7.86 (dd, J=5.3, 3.2 Hz, 4H), 7.73 (dd, J=5.3, 3.1 Hz, 4H), 4.43 (s, 4H). ¹³C NMR (126 MHz, CDCl3) δ 167.13, 134.30, 132.15, 123.70, 76.80, 27.30. FTIR (neat) vmax=1769.1, 1714.2. 1611.9. 1463.4, 1425, 1395.7, 1342.7, 1315.7, 1187.3, 1117.2, 1086.4, 946.7, 848.9, 796.01, 724.88, 626.55 cm⁻¹.

### But-2-yne-1,4-diamine

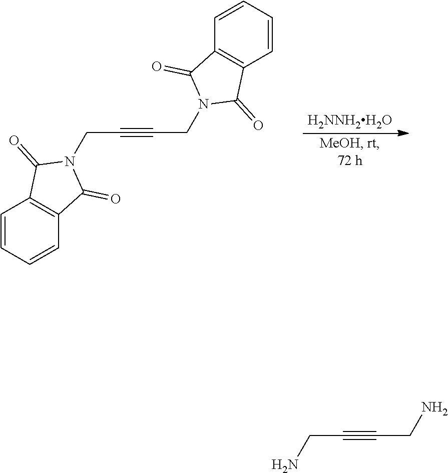 [SMILES: O=C1c2ccccc2C(=O)N1CC#CCN1C(=O)c2ccccc2C1=O ; "H2NNH2·H2O" ; "MeOH, rt,72 h" ; NCC#CCN]

To a 1000 mL RBF containing a mixture of 2,2′-(but-2-yne-1,4-diyl)bis(isoindoline-1,3-dione) (5.0 g, 14.5 mmol) stirred in 500 mL methanol was added hydrazine monohydrate (13.3 mL, 274 mmol) and was allowed to stir at room temperature for 72 h under argon in the absence of light. 250 mL of methanol was added to the mixture and then was filtered. The filtrate was concentrated under reduced pressure to afford the crude product as an off-white solid. The crude product was then extracted with 150 mL of methylene chloride, shaken with anhydrous sodium sulfate, and filtered. Removal of the solvent yielded the product as a light-green solid, which was stored at −30° C. in an amber vial (862 mg, 83% yield). ¹H NMR (500 MHz, DMSO-d6) δ 3.25 (s, 4H), 2.80 (br, 4H). ¹³C NMR (126 MHz, DMSO-d6) δ 83.25, 30.87. FTIR (neat) vmax=3270.7, 3211.1. 3175.7, 3053.6, 3013.6, 2988.4, 2925.0, 2899.9. 2864.5, 1973.6, 1901.9, 1835.7, 1736.9, 1708.1, 1651.2, 1590.4, 1538.5, 1504.9, 1484.4, 1437.8, 1347.4, 1312.0, 1233.7, 1181.6, 1157.3, 1120.1, 1071.6, 1041.8 cm⁻¹.

### But-2-yndioyl dichloride

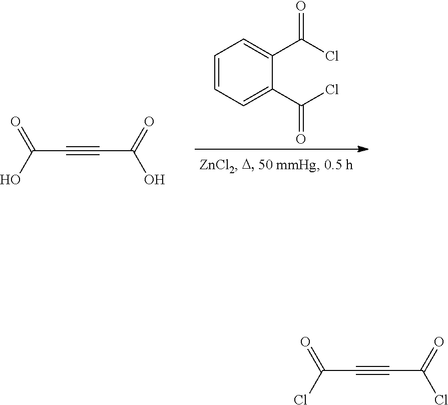 [SMILES: O=C(O)C#CC(=O)O ; O=C(Cl)c1ccccc1C(=O)Cl ; O=C(Cl)C#CC(=O)Cl]

Synthesis of but-2-ynedioyl dichloride was found to be not straightforward as traditional chlorinating agents such as thionyl chloride and phosphorous pentachloride resulted in no product or a mixture of inseparable phosphorous byproducts. An appropriate method described by Vereshchagin et al. used phthaloyl chloride as a chlorinating agent successfully and is described here: but-2-ynedioic acid (11.4 g, 100 mmol) was added to a 150 mL three-neck RBF containing a mixture of phthaloyl chloride (30 g, 21 mL, 150 mmol) and anhydrous zinc chloride (2.7 g, 20 mmol) under argon. Upon heating under reduced pressure (50 mmHg), the reaction mixture foamed. A fraction boiling in the range from 100 to 120° C. (50 mmHg), was collected; containing the desired diacid chloride product as colorless liquid (5.28 g, 35% yield).^{174 13}C NMR (126 MHz, CDCl3) δ 148.56, 79.38. FTIR (neat) vmax=3475.5, 3083.3, 2963.8, 2338.8, 2160, 2052.4, 1742, 1599, 1432.5, 1298.3, 1127.7, 1031.3, 931.86, 712.03, 571.66 cm⁻¹.

### Synthesis of Macromolecules

### General Synthetic Procedure for Interfacial Polymerization

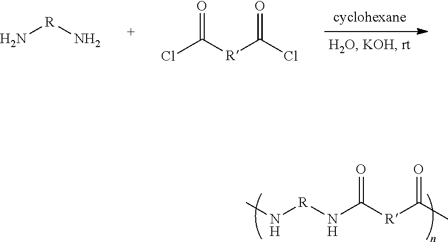

To a 50 mL beaker charged with a solution of diamine (0.4 M) and potassium hydroxide (1.2 M) dissolved in 10 mL DI water was slowly added a solution of diacid dichloride dissolved in 27 mL cyclohexane (0.15 M). After 10 min, the interface of the fluids was disturbed with tweezers to collect the forming polymer. Consecutive washes and filtrations with DI water, methanol, acetone, followed by drying under high vacuum overnight yielded the final polymeric products.

### Poly((hexa-1,4-diynyl)-adipamide) (PHDA)

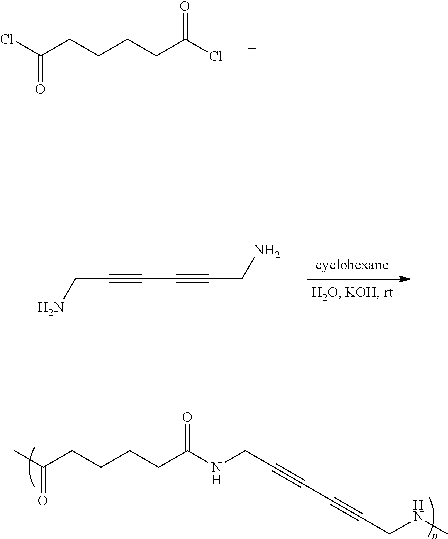

Synthesis of PHDA was carried out by following the general interfacial polymerization procedure (199 mg, 40% yield). FTIR (neat) vmax=3429.2, 2956.7, 2920.0, 2848.7, 2260.4, 1633.6, 1382.9, 1336.6, 1259.4, 1195.8, 1134.1, 1101.3, 1024.1, 923.8, 798.5, 574.7 cm⁻¹.

### Poly((hexa-1,4-diynyl)-sebacamide) (PHDS)

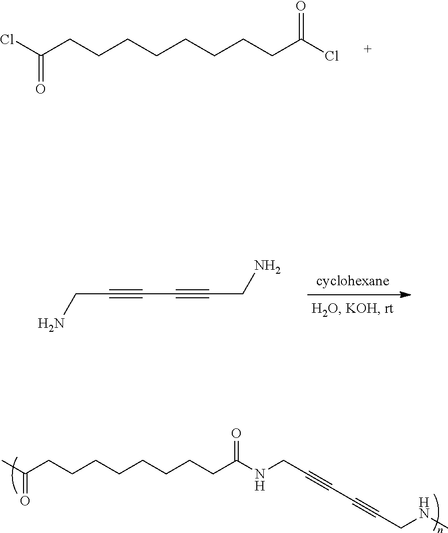

Synthesis of PHDS was carried out by following the general interfacial polymerization procedure (276 mg, 25% yield). FTIR (KBr) vmax=3431.1, 3062.7, 2921.9, 2850.6, 2258.5, 1936, 1816.8, 1637.4, 1537.2, 1490.9, 1411.8, 1348.1, 1313.2, 1282.6, 1157.2, 1112.8, 1043.4, 1016.4, 981.7, 921.9, 862.1, 808.1, 729.0, 661.5, 567.0 cm⁻¹.

### Poly((hexa-1,4-diynyl)-terephthalamide) (PHDT)

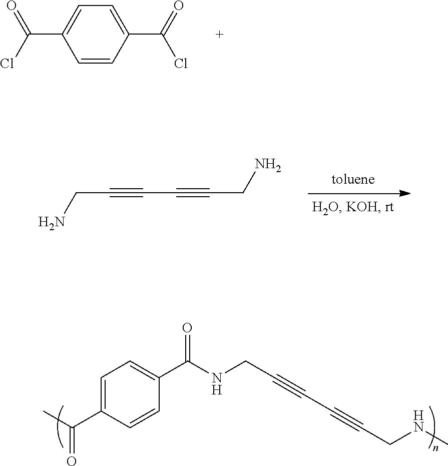

Synthesis of PHDT was carried out by following the general interfacial polymerization procedure using toluene as the organic phase (209 mg, 22% yield). FTIR (KBr) vmax=3431.1, 3062.7, 2921.9, 2850.6, 2258.5, 1936, 1816.8, 1637.4, 1537.2, 1490.9, 1411.8, 1348.1, 1313.2, 1282.6, 1157.2, 1112.8, 1043.4, 1016.4, 981.7, 921.9, 862.1, 808.1, 729.0, 661.5, 567.0 cm⁻¹.

### Poly((hexa-1,4-diynyl)-fumaramide) (PHDF)

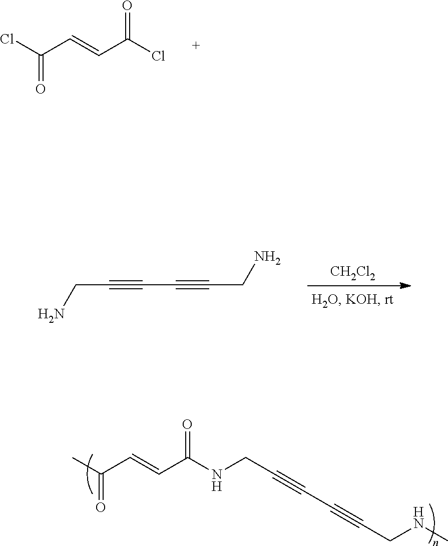

Synthesis of PHDF was carried out by following the general interfacial polymerization procedure using methylene chloride as the organic phase, requiring reverse addition of the liquids (183 mg, 24% yield). FTIR (KBr) vmax=3427.3, 3288.4, 3058.9, 2923.9, 2852.5, 2256.5, 2144.7, 1851.5, 1629.7, 1539.1, 1433.0, 1359.7, 1307.6, 1186.1, 1080.1, 1022.2, 970.1, 879.5, 802.3, 765.7, 651.9, 572.8 cm⁻¹.

### Poly((hexa-1,4-diynyl)-but-2-ynediamide) (PHDBY)

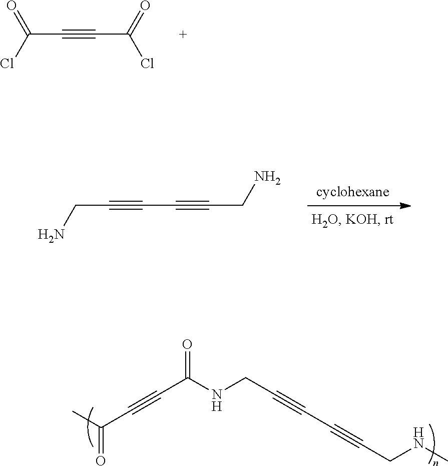

Synthesis of PHDBY was carried out by following the general interfacial polymerization procedure (387 mg, 51% yield). FTIR (KBr) vmax=3431.1, 2927.7. 2858.3. 2106.1, 1639.4, 1421.4, 1384.8, 1344.3, 1257.5, 1151.4, 1099.3, 1016.4, 935.4, 800.4 cm⁻¹.

### Poly((hexamethylene)-but-2-ynediamide) (PHBY)

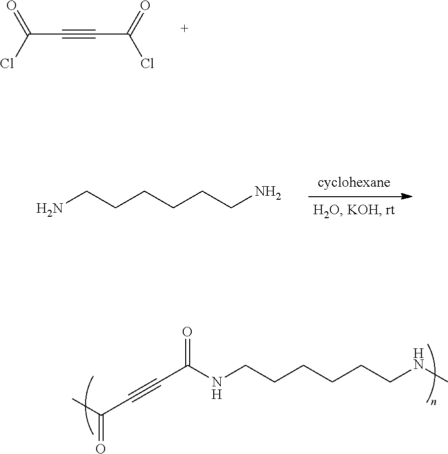

Synthesis of PHMBY was carried out by following the general interfacial polymerization procedure (464 mg, 59% yield). FTIR (KBr) vmax=3431.1, 3074.3, 2927.7, 2854.4, 2086.82, 1623.9, 1537.2, 1461.9, 1434.9, 1371.3, 1297.9, 1232.4, 1176.5, 1135.9, 1083.9, 1027.9, 871.8, 781.1, 725.2, 659.6 cm⁻¹.

### Poly((2-butynyl)-but-2-ynediamide) (PBBY)

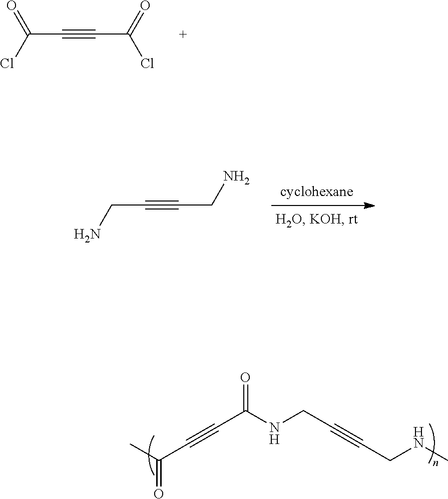

Synthesis of PBBY was carried out by following the general interfacial polymerization procedure (262 mg, 40% yield). FTIR (KBr) vmax=3456.2, 2921.9, 2852.5, 2605.6, 2104.2, 1643, 1529.4, 1425.3, 1390.6, 1344.3, 1263.3, 1143.7, 1103.2, 1031.8, 765.7, 621.0 cm⁻¹.

### Synthesis and Characterization of Latent-DDA Prepolymers

This example describes DDA reactions that be used on extended polymeric systems to produce highly aromatic materials and yield highly aromatic carbonaceous materials.

In order to synthesize latent-DDA prepolymers, careful selection of monomers must first be considered. As DDA reactions require unsaturated moieties, typical precursors will be thermally and potentially photochemically active. Therefore, monomer synthesis must proceed under moderate conditions. Moreover, to enhance DDA reactivity, the formed polymer will need to contain relatively short tethers between the reactive DDA groups to promote intramolecular reactions.

Lastly, special consideration of the polymerization method is required as the reaction will need to occur under mild conditions and form high molecular weight polymers with ease as acetylenic polymers notoriously have poor solubility. Typical methods of forming polymers containing diacetylene moieties consist of using a bi-terminal alkyne which then undergoes a carbon coupling reaction such as Glaser-Hay or Sonogashira. Unsurprisingly, both of these methods yield lower molecular weight polymers and have lesser degree of freedom for monomer choice. A more preferred polymerization technique would feature high reaction rates to instantaneously yield high molecular weight polymers. One such method is by an interfacial polymerization of a diamine and diacid chloride to form polyamides.

### Monomer Synthesis

Based on synthetic analysis, we found the formation of a diyne-containing diamine and acetylene-containing diacid chloride to be synthetically accessible. The desired diamine was prepared in three steps by using the economically accessible acetylene-containing precursor, propargyl alcohol (Scheme 2). First, the propargyl alcohol underwent homocoupling under Glaser-Hay conditions at room temperature to yield diyne diol (1). Successful isolation of 1 was rather simple and consisted of using basic alumina to remove lingering copper species followed by removal of unreacted propargyl alcohol and excess solvent under vacuum. The diyne diol (1) then underwent a Gabriel synthesis by the Mitsunobu reaction with phthalimide to yield the diphthalimide diyne (2). Isolation of (2) was rather straightforward as the formed diphthalamide diyne is incredibly insoluble in THF and therefore was purified by THF washing. Moreover, (2) is found to be incredibly photochemically stable at room temperature and does not undergo the aforementioned diyne topochemical polymerization.

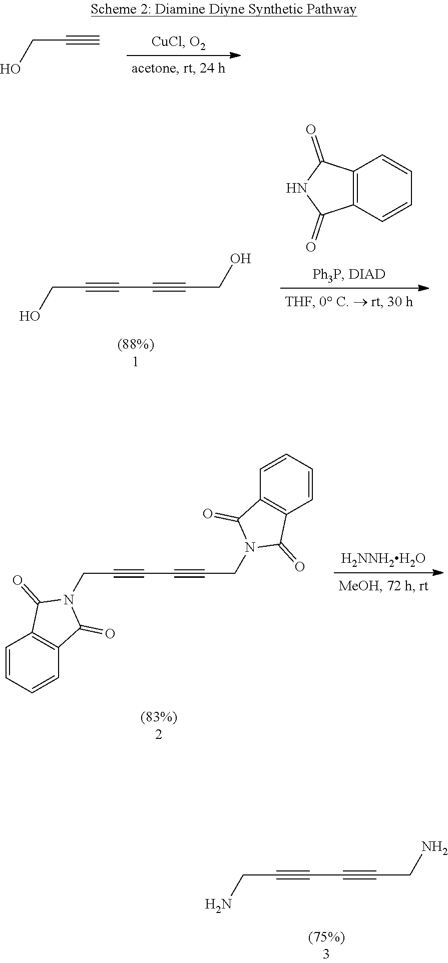

Subsequent hydrazinolysis of (2) by hydrazine monohydrate at room temperature completed the Gabriel reaction to afford the diamine diyne (3). Serendipitously, isolation of (3) followed a two-step extraction. First, with methanol followed by methylene chloride to yield pure diamine diyne (3). The overall synthetic pathway is quite advantageous as (2) is shelf-stable and can be readily converted to (3) for the fresh diamine diyne monomer (3). Moreover, none of the synthetic steps require isolation by silica chromatography.

Following a similar synthetic pathway, a diamine containing a monoyne 5 was also prepared (Scheme 3).

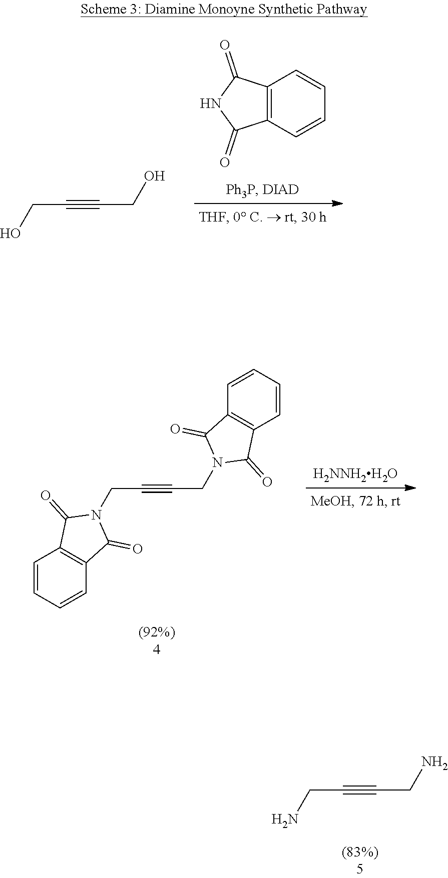 [SMILES: O=C1NC(=O)c2ccccc21 ; OCC#CCO ; O=C1c2ccccc2C(=O)N1CC#CCN1C(=O)c2ccccc2C1=O ; "H2NNH2·H2O" ; NCC#CCN]

Synthesis of the acetylene-containing diacid chloride (6) was found to be not straightforward as traditional chlorinating agents such as thionyl chloride and phosphorous pentachloride resulted in no product or a mixture of inseparable phosphorous byproducts (Scheme 4). An appropriate chlorinating method described by Smirnov and coworkers consists of employing phthaloyl chloride as a chlorinating agent. Isolation of the diacid chloride occurred as the reaction progressed by trapping the product via a liquid nitrogen trap under low pressure (~50 mmHg)

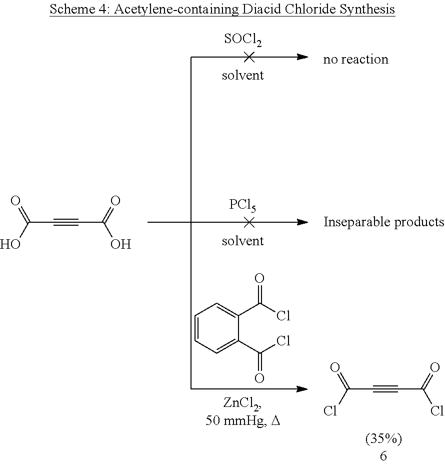 [SMILES: "SOCl2" ; O=C(O)C#CC(=O)O ; "PCl5" ; O=C(Cl)c1ccccc1C(=O)Cl ; O=C(Cl)C#CC(=O)Cl]

### Factors Affecting Interfacial Polymerization

As polyamides, also known as nylons, follow step-growth kinetics, obtaining high molecular weight products is challenging due to being governed by Carother's equation (equation 1), where the degree of polymerization, Xn, is heavily dependent on the monomer conversion p.

$${\overline{X}}_{n} = \frac{1}{1 - p} \qquad ( equation 1 )$$

As the kinetics for interfacial polymerizations are distinctly different from step-growth, the limitations of Carother's equations are no longer applicable. Interfacial polymerizations of nylons typically employ a diamine and a diacid chloride as monomers. The simplest version is an unstirred interfacial polymerization, more commonly known as the nylon rope trick and has been widely used as a laboratory demonstration for the polymerization of nylon. Originally discovered in 1959 by Morgan and coworkers, the nylon rope trick consists of an unstirred biphasic system of an organic solution containing a diacid chloride and an aqueous solution containing a diamine. The typical procedure consists of pouring the aqueous solution into a beaker followed by a careful slow addition of the diacid chloride organic solution while not disturbing the aqueous phase below. As the diamine diffuses to the diacid chloride-containing solution, a thin reaction zone is created as the amino group attacks the carbonyl in a typical SN2 fashion (Scheme 5). After formation of the amide, HCl is formed as a byproduct and forms a salt with unreacted diamine. The ammonium salt is then readily be converted back by deprotonation from the addition of an inorganic base such as KOH.

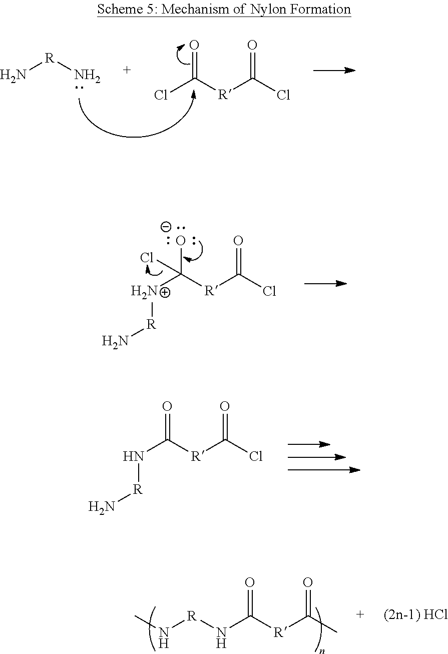

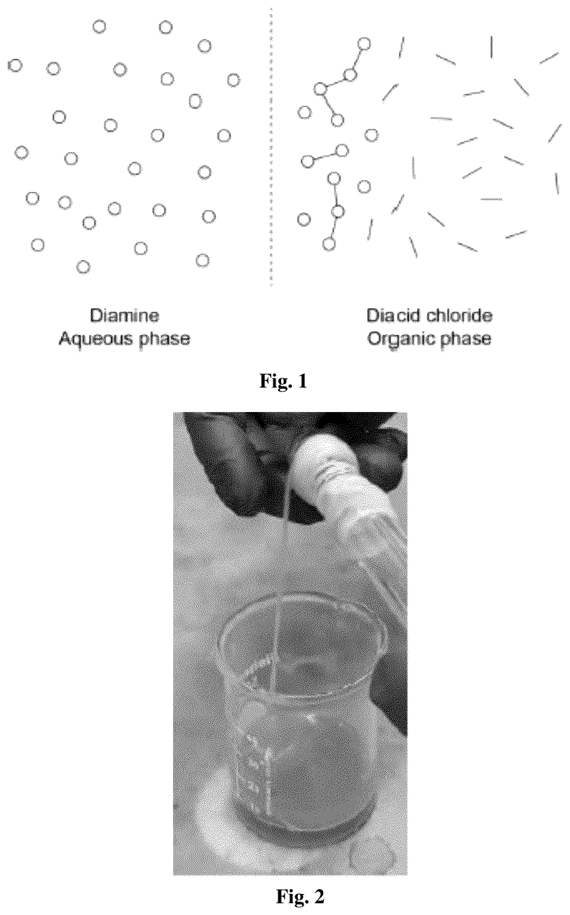

After a sufficient number of sequential reactions, oligomers and polymers begin to form near the interface of the biphasic system (FIG. 1). Once a dense barrier layer is formed, the diffusion of the monomers is hindered, which then decelerates film formation. At a high enough molecular weight, the formed film can be drawn into a rope and collected by using tweezers. While being drawn, the dense barrier layer is removed, allowing the polymer to form with ease at the interface until removal of either monomer or solvent phase.

As the polymeric film forms instantaneously, the reaction rate is therefore governed by diffusion. Polyamides exhibiting high permeability follow a quasi-diffusion limited model where a gradual transition to the classic diffusion model will occur.

Other variables that typically affect the interfacial polymerization are:
1. Reaction rate (diffusivity)
2. Polymer solubility
3. Monomer purity
4. Partition coefficient of diamine
5. Concentration
6. Solvent choice

As mentioned, the reactants need to have high enough reaction rates to be diffusion-limited to easily form a high molecular and drawable nylon rope. If the solubility of the polymer is too high, a film may not form at the interface. Conversely, if the solubility of the polymer are too low, low molecular weight oligomers will form at the interface and will be unable to be drawn into a rope. Solvent choice of the organic phase should be considered in being able to form a high molecular weight polymer. This directly affects the polymer solubility and reaction rate. The molecular weight and reaction rate are heavily affected by the ability of the diamine to diffuse to the organic phase. Diffusion is greatly affected by the partition coefficient, P, which can be described as the preference of solvent between two immiscible liquids of the diamine. The partition coefficient which is the ratio of the concentration found between the two liquids and can be expressed as (equation 2) for the diamine.

$$P = {C}_{{H}_{2} O} / {C}_{Organic solvent} \qquad ( equation 2 )$$

### Interfacial Polymerization of DDA-Latent Prepolymers

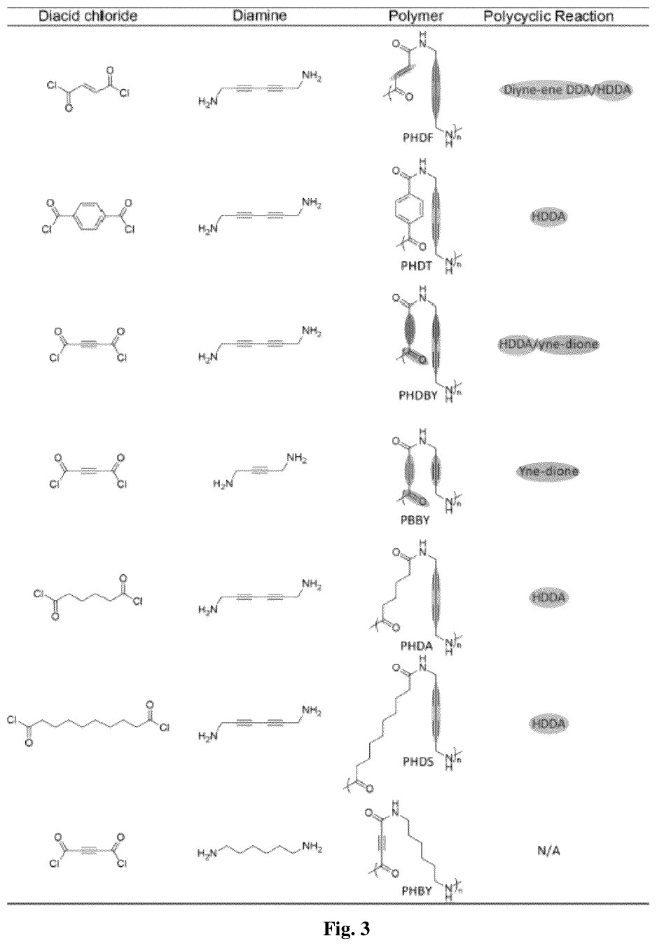

Latent dehydro-Diels-Alder polymers were then prepared by using custom and commercial monomers following a modified unstirred method. In the absence of light, the respective diacid chloride was dissolved in cyclohexane. The respective diamine and KOH were both dissolved in deionized (DI) water. The less-dense phase was slowly added to the denser phase charged in a 50 mL beaker. The monomers were allowed to react for 10 min before being disturbed with tweezers and drawn into a rope. (FIG. 2) The collected prepolymer was washed with liberal amounts of DI water, methanol, acetone, filtered after each successive wash, and dried under high vacuum overnight. Unsurprisingly, the resulting polymeric materials were found to be insoluble in methylene chloride, acetone, methanol, toluene, o-dichlorobenzene, while being slightly soluble in hot glacial acetic acid and formic acid. A summary of the prepared polyamides and the corresponding DDA reaction is found in FIG. 3.

For the preparation of PHDF, the reactivity of the monomers appeared to not be sufficient to produce a drawable high molecular weight polymer by using cyclohexane as the organic solvent. Conversely, using methylene chloride as the organic solvent increased the reactivity sufficiently for the formed polymer to be drawn into a rope. The higher reactivity of the monomers in methylene chloride is likely due to the increased partition coefficient of the chlorinated solvent. Moreover, it should be noted that by interchanging the organic solvent from cyclohexane to methylene chloride, the density of the organic phase will be higher than the aqueous phase containing the diamine. Therefore, the organic phase should be initially added to the 50 mL beaker prior to the aqueous phase. Similarly, the preparation of PHDT was found to be not successful in cyclohexane. By changing the organic solvent from cyclohexane to toluene, the polymer was successfully able to be drawn and collected into a rope. The poor reactivity in cyclohexane is most likely attributed to the poor solubility of terephthaloyl chloride in cyclohexane, whereas toluene easily dissolves the diacid chloride.

It should be noted for all the prepared polyamides containing hexa-2,4-diyne-1,6-diamine or but-2-yne-1,4-diamine, the interfacial polymerization is found to be quite sensitive to monomer impurities and therefore should be carried out with freshly prepared diamines.

### Thermal Gravimetric Analysis

Initial thermal studies of each DDA-prepolymer were carried out via thermal gravimetric analysis (TGA). Each dried sample underwent three separate runs of heat treatment from 30-1000° C. with a heating ramp of 10° C./min under nitrogen. An average and standard deviation were calculated and plotted for each prepolymer. The associated weight loss derivatives were also tabulated and plotted, giving insight into decomposition regions and extrema. It should be noted, as nylons hydrogen bond readily with moisture, it is challenging to completely remove moisture. Even brief exposure to atmospheric moisture enables moisture to reabsorb to nylons. Evidence of this can be seen for each prepared DDA-prepolymer with initial minor decompositions up to 150° C.

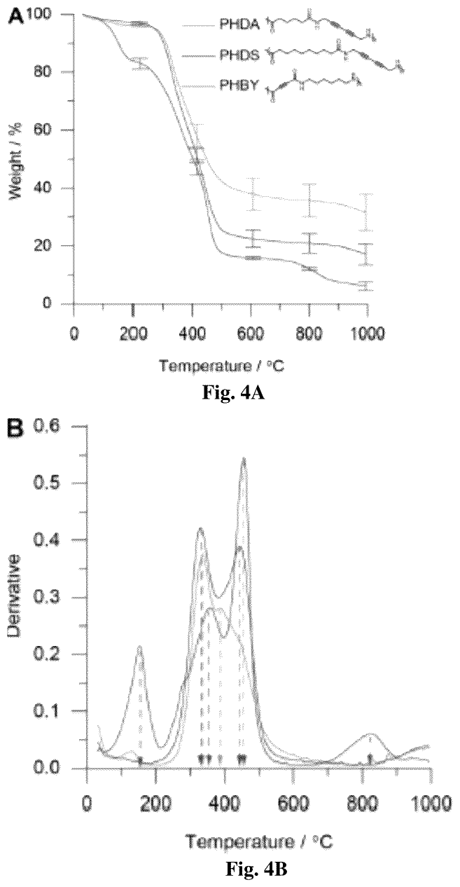

Alkyl-based derivatives, PHDA, PHDS, and PHBY, were universally found to have lower char yields ranging from 6-31% (FIG. 4A-B). PHBY, a non-DDA active prepolymer control, was found to undergo several decompositions. The first decomposition occurs from 85-215° C. (150° C. extremum) and results in 14% weight loss. A second decomposition occurs in two stages from 250-500° C. The first decomposition stage begins at 250 until 400° C. with an extremum at 360° C. and a further 31% weight loss. Upon the second stage of decomposition 400-500° C., a further 33% weight loss is observed with a weight loss extremum at 455° C. The third and final decomposition is observed from 780-1000° C. with two distinct stages. The first stage begins at 780° C. until 905° C. with a weight loss of 5.5% and weight loss extremum at 825° C. The second decomposition stage is minor with 1.6% weight loss from 905-1000° C.

PHDA and PHDS DDA-prepolymers are structurally similar and have similar decomposition profiles. PHDA and PHDS are thermally stable and undergo minimal decomposition until 255° C., where both DDA-prepolymers undergo a major decomposition with two distinct stages until 540° C. The first decomposition stage begins from 255° C. until 380° C. and results in a weight loss of 28% for PHDA and weight loss of 34% for PHDS. Both PHDA and PHDS decomposition extremums within this stage are observed around 330° C. The second decomposition stage occurs from 380° C. until 540° C. and results in an additional weight loss of 28% for PHDA and weight loss of 38% for PHDS. Interestingly, the extremum during this decomposition stage occurs at an earlier temperature for PHDA (390° C.) compared to the extremum of PHDS (445° C.). Moreover, the extremum magnitude of PHDS is significantly larger than the extremum of PHDA. As PHDA and PHDS are structurally similar and contain the DDA-prone hexa-2,4-diyne-1,6-diamine moiety, the disparity in char yields and extremum can be attributed to the loss of the additional 4 methylene groups in PHDS.

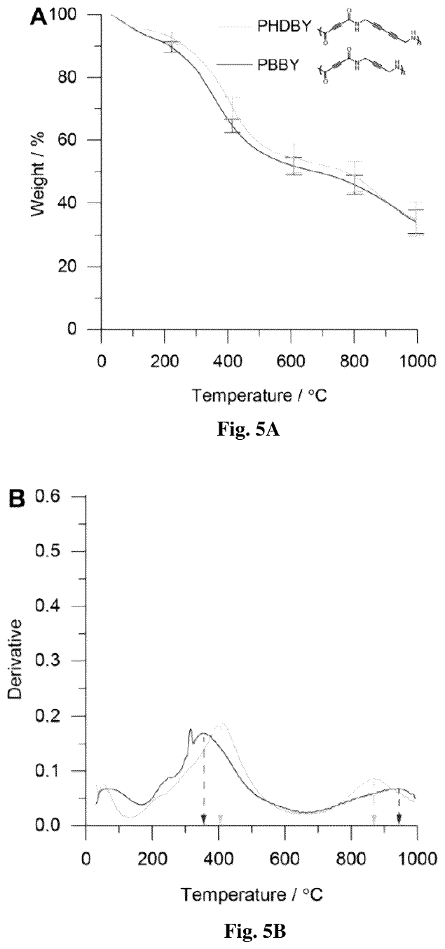

Higher char-yielding alkynyl DDA-prepolymers, PHDBY and PBBY, thermally behaved similar and yielded char yields around 35% at 1000° C. (FIG. 5A-B). PHDBY undergoes an initial decomposition from room temperature until 130° C. with 5% weight loss. Similarly, PBBY undergoes an initial decomposition from room temperature until 175° C. with 8% weight loss. Around 175° C., both PHDBY and PBBY undergo a significant decomposition until 600° C. During this decomposition, PHDBY undergoes a weight loss of 40%, with an observed extremum at 405° C. The decomposition of PBBY is similar and loses 39 wt. %, however, the decomposition contains a small decomposition shoulder at 245° C. and the decomposition extremum is observed at an earlier temperature at 355° C. The final decomposition for PHDBY and PBBY occurs from 750° C. until 1000° C. and results in a weight loss ~15%. During decomposition, the decomposition extremum for PHDBY is observed at an earlier temperature of 865° C., whereas PBBY's is observed at 950° C. The overall thermal behavior of PHDBY and PBBY is similar yet slightly differs. More insight into the thermal behavior can be extracted from the thermograms as PBBY and PHDBY are structurally similar. The prepolymer PBBY contains yne-dione isomerization functionalities, whereas PHDBY contains HDDA and yne-dione isomerization. As both polymers thermally behave similar, it can be concluded that PHDBY appreciably participates in the competitive yne-dione isomerization. Moreover, it can also be suggested that the observed minor differences are due to the additional acetylene moieties or due to the minor HDDA products that are formed.

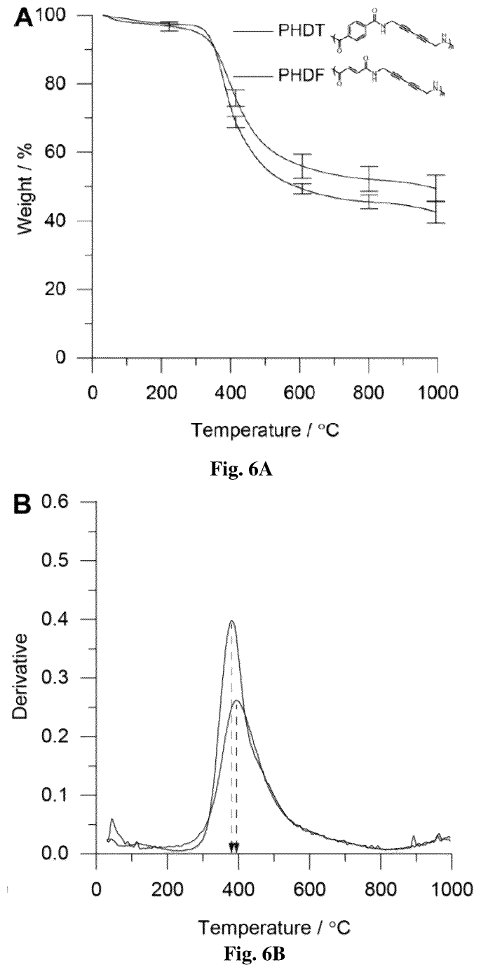

The highest char yielding DDA-prepolymers, PHDF, PHDT, thermally behaved similar (FIG. 6A-B). Both prepolymers were thermally stable up to 285° C. with insignificant weight loss due to adsorbed moisture. Heating past 285° C. resulted in a significant decomposition until 600° C. with weight losses of 42% and 46% for PHDF and PHDT respectively. The decomposition extremum for PHDT occurred at an earlier temperature of 380° C., whereas the decomposition extremum of PHDF occurred at 395° C. Heating PHDF and PHDT past 600° C. up to 1000° C. resulted in no distinct major decomposition and resulted in char yields 49% and 42% respectively.

### Differential Scanning Calorimetry Analysis

Differential scanning calorimetry (DSC) has previously been used to correlate extrapolated exotherm onset temperatures with cyclization activation energies of HDDA-prone organic molecules, which was found to be in good agreement. Moreover, it was also found that shifts to higher onset temperatures are often a result of bimolecular reactions of generated benzynes with another polyyne substrate, resulting in an intermolecular reaction instead of an intramolecular reaction.

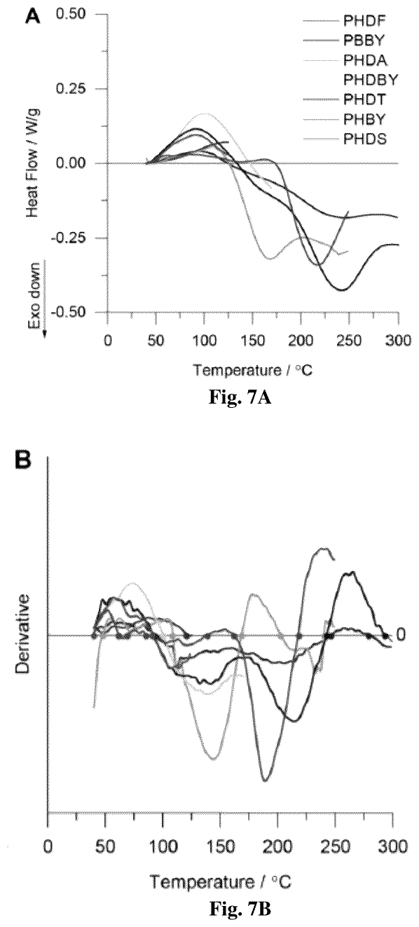

Each prepared prepolymer, in a hermetically sealed aluminum pan, underwent two cycles of heating and cooling from 30° C. to the decomposition temperature at 5% weight loss (T5%) and back to 30° C. with a heat ramp of 10° C./min (FIG. 7A-B). Two heating cycles were performed to ensure that the observed broad-exothermic peaks were irreversible transitions, which is a key characteristic of a chemical reaction occurring instead of a physical change. Additionally, as aforementioned, complete removal of adsorbed moisture is challenging for nylons as they are hydrophilic. Therefore, the observed initial endotherms we attribute to the evaporation of adsorbed moisture. Extrapolated onset temperatures (TON) were calculated and recorded at the point where the extrapolated baselines and tangential lines of the exotherms intersect (Table 1).

TABLE 1
Estimated Onset Temperatures for DDA-latent Prepolymers

| Entry | Tether | T₁ ON | Transition | T₂ ON | Transition |
|---|---|---|---|---|---|
| PHDF | Alkenyl | 120° C. | Intramolecular | 150° C. | Intermolecular |
| PHDT | Phenyl | 135° C. | Intramolecular | 170° C. | Intermolecular |
| PHDBY | Diynyl | 144° C. | Intramolecular | — | — |
| PBBY | Alkynyl | — | — | — | — |
| PHDS | Alkyl | 175° C. | Intermolecular | — | — |
| PHDA | Alkyl | 125° C. | Intramolecular | 160° C. | Intermolecular |
| PHBY | Alkyl | — | — | — | — |

DSC scans of alkenyl and phenyl derivatives (PHDF & PHDT) contained water evaporation endotherms followed by a broad exotherm containing two peaks. The first onset temperature (T1 ON) of PHDF and PHDT at 120° C. and 135° C., respectively, can be attributed to intramolecular reactions occurring, whereas the higher second onset temperature (T2 ON) at 150° C. and 170° C., respectively, can be attributed to intermolecular reactions occurring.

DSC scans of alkynyl derivatives (PHDBY, PBBY, and PHBY) early endotherms are due to adsorbed moisture evaporation for each sample. Due to the low T5%, the examined temperature range was restrictive, resulting in limited thermal analysis. Having the least degradation, it was possible to observe an exotherm TON for PHDBY at 144° C., suggesting the occurrence of a chemical reaction.

Alkyl-tethered derivatives (PHDA & PHDS) both contained early endotherms, due to adsorbed moisture evaporation, followed by a broad exotherm. The exotherm behavior differed as PHDA contained two exotherm onset temperatures (T1 ON & T2 ON) at 125° C. and 160° C., whereas PHDS only exhibited a T1 ON at 175° C. The first transition at 125° C. can be attributed to an intramolecular reaction occurring and the second higher onset temperature at 160° C. can be attributed to an intermolecular reaction occurring. The higher exotherm onset temperature of PHDS can be attributed to an intermolecular reaction occurring. This is likely due to the increase of 4 methylene groups in PHDS, increasing the distance between the reactive groups within the chain, which could cause intermolecular reactions to be more favorable than intramolecular.

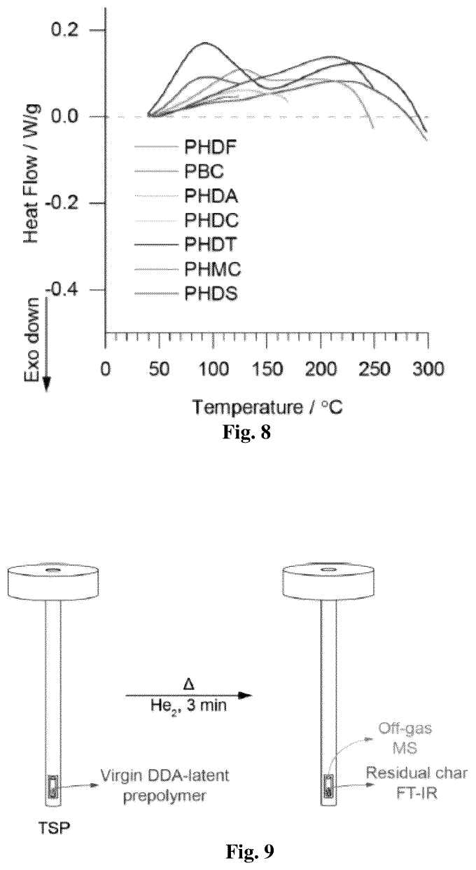

For all the prepolymers containing exotherm onset temperatures, no broad exotherms were observed in the second heating scan within the same temperature regimes, suggesting the occurrence of an irreversible chemical reaction (FIG. 8).

### Thermal Separation Probe-Mass Spectroscopy Analysis

To gain further insight into thermal decomposition of each prepolymer, a thermal separation probe couple with a mass spectrometer (TSP-MS) was used to peruse the gases evolved during heat treatment at 150° C., 250° C., and 400° C. under a helium atmosphere for 3 min (FIG. 9). After, the resulting chars were characterized with FT-IR equipped with a germanium ATR module.

The low char-yielding DDA-latent prepolymers, PHBY, PHDA, and PHDS, were first examined. Analysis of the first major decomposition of PHBY (14% weight loss) from 85-215° C. indicated evolution of higher molecular weight fragments via MS at 150° C. with minor amounts of N2 and CO₂. Conversely, PHDA and PHDS did not decompose significantly (<3.5% weight loss) within this temperature regime and yielded fragments primarily associated with N₂ and CO₂ at 150° C. Furthermore, during this heat treatment, PHDA undergoes an intramolecular reaction as seen via DSC, whereas no reaction is observed for PHDS.

From 215-400° C., PHBY undergoes another significant decomposition (31% weight loss). TSP-MS analysis during this decomposition at 250° C. indicated significant evolution of N2 and minor amounts of higher molecular weight fragments (<100 m/z) with a fragmentation profile of m/z≈12-14, suggesting chain scission. At 250° C., PHDA and PHDS remained stable and decomposed slightly (~5%). During this heating as seen in DSC, PHDA and PHDS undergo an intermolecular reaction as seen via DSC. Gaseous byproducts evolved during heat treatment yielded higher molecular weight fragments (<150 m/z) with evidence of minor chain scission (profile of m/z≈12-14).

From 400-500° C., PHBY undergoes a final major decomposition (33% weight loss). TSP-MS analysis at 400° C. revealed evolution of higher molecular weight fragmentation occurring primarily from m/z=40-100. As PHBY contains no DDA-active moieties, the low char yield and major fragmentation profiles are expected. Moreover, the significant decomposition within this temperature regime is consistent with previous decomposition studies of non-charring nylons. From 380-540° C., PHDA and PHDS both undergo a second-stage decomposition of the final decomposition region (PHDA weight loss of 28% and PHDS weight loss of 34%). TSP-MS analysis during this decomposition at 400° C. revealed significant fragmentation of PHDS with m/z values ranging from 40-124 with similar relative abundance and evidence of chain scission. Conversely, PHDA yielded primarily fragments under m/z values of 60 with minor amounts of high molecular weight fragments and evidence of chain scission.

Alkynyl-tether derivatives, PHDBY and PBBY, were then examined. Until the first major decomposition (~175-600° C., ~39% weight loss), both PBBY and PHDBY are thermally stable and primarily evolve N₂ and CO₂. TSP-MS analysis of the first major decomposition of PBBY and PHDBY at 250° C. revealed N₂ and CO₂ as the primary gaseous byproducts, with no evidence of chain scission. At 400° C., both PBBY and PHDBY primarily evolved N₂ and CO₂, with some evidence of PHDBY chain scission. It should be noted that at 400° C., PHDBY is at a weight loss extremum, possibly the cause of higher molecular weight m/z abundance.

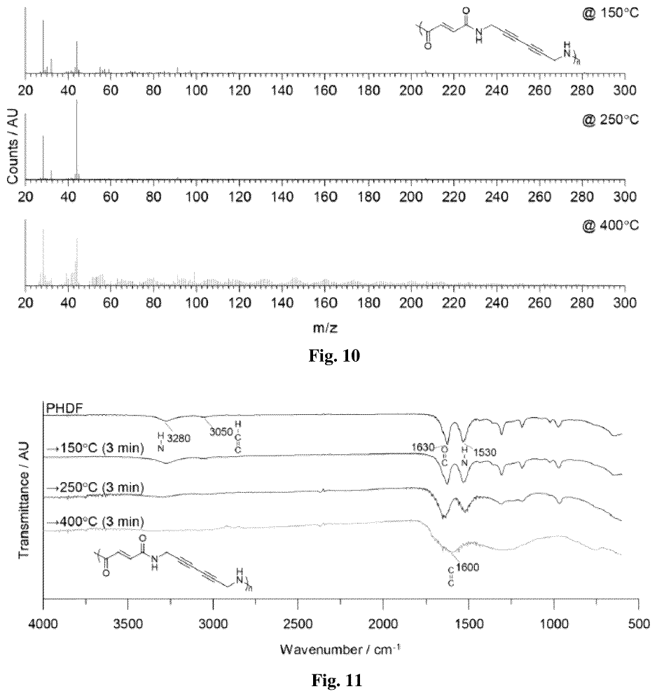

The highest char-yielding DDA-latent prepolymers, PHDT and PHDF, were then examined (FIG. 10). TSP-MS analysis at 150° C. of PHDF and PHDT gave insight into the gaseous byproducts of the intramolecular transformation as seen in DSC. Both PHDF and PHDT underwent no significant decomposition and primarily evolved N₂ and CO₂, with some larger fragmentation for PHDT (m/z<100) at 150° C. At 250° C., both PHDF and PHDT undergo intermolecular reactions and primarily evolved smaller fragments with N₂ and CO₂ as the main gaseous byproducts. From 285-600° C., both PHDF and PHDT undergo a significant decomposition, with a mass loss extrema observed around 400° C.

TSP-MS analysis at 400° C. revealed high molecular weight fragments with an m/z fragmentation profile of 12-14, consistent with chain scission. With PHDT, higher molecular weight fractions (m/z≈150, 130) were the highest abundant evolved gaseous byproducts, with minimal amounts of N₂ and CO₂. Conversely, PHDF evolved primarily N₂ and CO₂ with minimal amounts of higher molecular weight fragments, with evidence of chain scission.

The FT-IR spectra of the comparison virgin and TSP-MS residual chars of PHDF, PHDA, PHDBY, and PBBY (FIG. 10) showed a decreased intensity of C═O (v≈1640 cm⁻¹), N—H (v≈3300 and 1540 cm⁻¹), and CO—NH in-plane (v≈980 cm⁻¹) bands with increasing temperature to 250° C., as in agreement with the evolution of N₂ and CO₂ observed in TSP-MS.

At 400° C., almost complete disappearance of C═O, N—H, and CO—NH in-plane related bands with an emergence of a new peak with-in aromatic C═C region (v≈1575-1600 cm⁻¹) is observed, consistent with polycyclic formation. Contrary, the FT-IR spectra of PHDT showed little difference with increasing the temperature to 250° C. At 400° C. the transmittance of PHDT significantly decreased, providing little structural insight into the low-absorbent material., which is consistent with carbonaceous materials. Similarly, the observed C═O, N—H, and CO—NH in-plane related bands of PHDS only decreased in transmittance. We attribute the absence of C═C aromatic bands within carbonized PHDS at 400° C. due to the long tether methylene moieties prohibiting intramolecular reactivity. It is likely that the intramolecular HDDA reaction is less favorable due to proximity constraints, thus favoring intermolecular reactions instead as suggested by DSC. Therefore, it is critical to have the corresponding DDA reactive groups close in proximity to promote intramolecular reactions to form aromatic moieties under mild thermal treatment.

FT-IR analysis of virgin and TSP-MS chars of PHBY showed minimal structural changes at 150° C. When being heated to 250° C. and 400° C., the intensity of the N—H band (v z 3300 and 1540 cm⁻¹) decreased, which is in agreement with the evolution of N2 observed in TSP-MS. In addition, at 400° C., a new band formed at 1699 cm⁻¹, indicating a change in structure as a new C═O species is formed.

### DDA-Carbon Preparation and Characterization

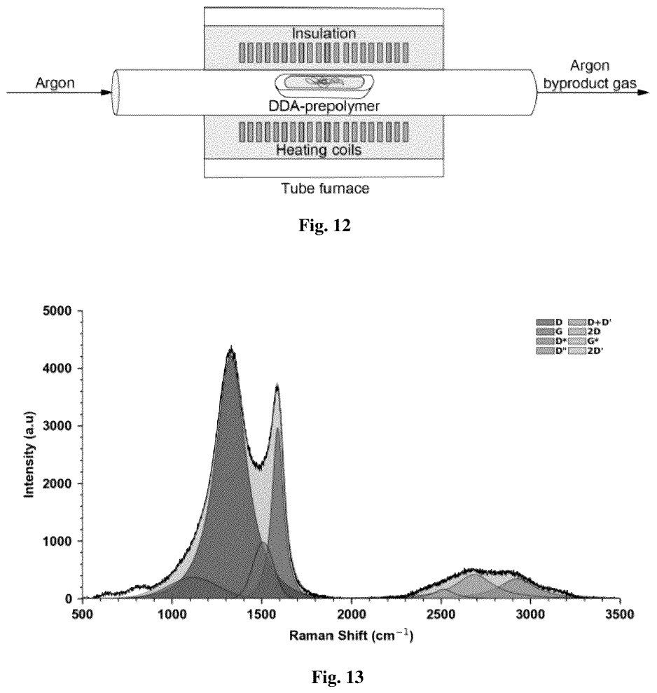

20-150 mg of each prepolymer was charged in an alumina boat crucible and then loaded in the tube furnace (FIG. 12). Argon then began to flow and purge the system for 15 min. After, each prepolymer underwent heat treatment in a tube furnace under an argon atmosphere at 15° C./min until 1000° C. was and then was held at that temperature for 20 min before cooling to room temperature. After complete heat treatment, the sample was collected and characterized by Raman spectroscopy and X-ray photoelectronic spectroscopy.

### Raman Spectroscopy

The obtained Raman spectra of the carbonaceous materials exhibits two main peaks that are attributed to the G and D band centered at ~1586 cm-1 and ~1345 cm-1 respectively, in addition to the second order bands centered ~2800 cm⁻¹.

The G band corresponds to planar sp2 bond-ed carbon within graphitic materials, whereas the D band corresponds to the breathing mode of sp2 bonded carbons, which causes defects within graphitic domains. Another band lies between the D and G peaks centered at ~1535 cm-1, D″, which has been reported for other carbon-based materials and is shown to be related to the amorphous domains of the material. A band centered ~1120 cm-1 was used to interpret the broad shoulder on the D band, called D*, which has been reported to be related to the disordered graphitic lattices provided by sp2-sp3 bonds.184

The deconvolved Raman spectrums of each carbonaceous material are similar, suggesting that the material is structurally similar. (FIG. 13) The only differences in this region of the spectrum lies in the D* and D″ peaks. Carbonaceous samples of PBBY and PHDBY exhibited a slightly higher amorphous (D″) contribution compared to the other samples while also having a larger shoulder on the D band (D*) suggest these materials have slightly higher disordered graphitic lattices between sp2 and sp3 carbons.

In addition to these peaks, the ratio of the D to G band intensities (ID/IG) are typically used to describe the disorder of the graphitic materials. The ID/IG of each carbonaceous sample was found to be ≈1.2, with an exception of PBBY at 1.15, suggesting a slightly more overall ordered carbonaceous material, yet containing the highest disorder between sp2 and sp3 carbons.

### X-Ray Photoelectron Spectroscopy

Further characterization of the carbonaceous samples via survey XPS gave insight into atomic composition. XPS survey of high char yielding prepolymers PHDF, PHDT, and PHDBY all contained >96% carbon content with the exception of PBBY at 93%. Nitrogen and oxygen content was found to vary between high char yielding samples, with oxygen being the main source of heteroatom content. Low char yielding prepolymers PHDA, PHDS, and PHBY were found to have >94% carbon content, generally lower than the high char yielding counterparts. Similar to the high char yielding prepolymers, the heteroatom content varied between samples and primarily consisted of oxygen.

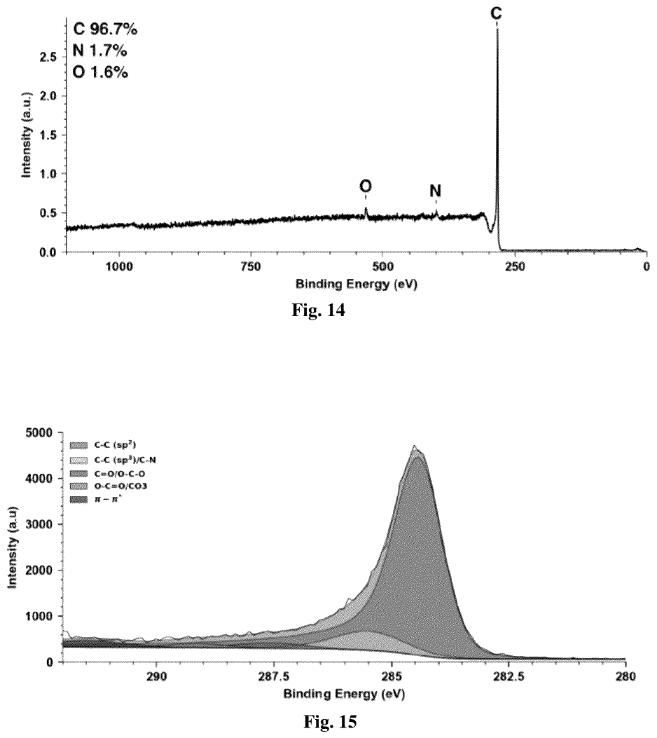

High-resolution XPS of the CIs region exhibits asymmetry which agrees with the expected peak shape of graphitized carbon. (FIG. 14) Additionally, the peak maximum is shifted towards lower binding energy (~284 eV) which indicates the material primarily consists of sp2 type carbon. Peak deconvolving involved five sub-peaks at 284.3, 285.3, 287.7, 290, and 291.5 eV corresponding to an asymmetric C═C (aromatic sp²) peak, C—C (sp³)/C—N, ketones/alcohols, esters/carbonates, and a satellite peak (π-π*) respectively. (FIG. 15) As found in Survey XPS, DDA-carbon contained low amounts of nitrogen content, typically <2% and therefore minimally contributes towards to corresponding C—C (sp³)/C—N peak at 285.3 eV.

The carbon content found in high char yielding prepolymers (PHDF, PHDT, PHDBY, and PBBY) contained sp2 carbon ranging from 79-83%, with PHDBY having the highest. Analysis of sp3 carbon content was found to range from 9-13%, with PHDBY having the lowest sp3 carbon content, while being the high char yielding material. sp2/sp3 ratios of the high char yielding prepolymers can be summarized in Table 3, showing PHDBY with the highest ratio at 7.7.

TABLE 2
Summary of Carbon Characterization
via XPS and Raman Spectroscopy

| | Char- | | | | C | C | C |
|---|---|---|---|---|---|---|---|
| | Yield | | | | (sp²) | (sp³) | (sp²/ |
| Entry | (%) | C % | N % | O % | % | % | sp³) |
| PHDA | 31.5 ± 6.3 | 94.5 ± 0.5 | 0.5 ± 0.4 | 5.0 ± 0.3 | 77.2 | 12.2 | 6.3 |
| PHDS | 17.0 ± 3.6 | 95.6 ± 0.3 | 2.0 ± 0.4 | 2.4 ± 0.5 | 79.1 | 13.2 | 6.0 |
| PHDT | 42.6 ± 3.1 | 96.4 ± 0.4 | 1.2 ± 0.3 | 2.3 ± 0.2 | 81.8 | 12.0 | 6.8 |
| PHDF | 49.4 ± 3.8 | 96.7 ± 0.5 | 1.7 ± 0.4 | 1.6 ± 0.2 | 81.4 | 13.0 | 6.3 |
| PHDBY | 35.1 ± 5.3 | 96.6 ± 0.5 | 3.0 ± 0.4 | 0.5 ± 0.3 | 83.3 | 10.8 | 7.7 |
| PHBY | 6.0 ± 1.4 | 94.2 ± 0.4 | 0.3 ± 0.2 | 5.5 ± 0.4 | 83.0 | 9.3 | 8.9 |
| PBBY | 34.2 ± 3.6 | 92.7 ± 0.5 | 1.9 ± 0.4 | 5.5 ± 0.3 | 79.4 | 11.6 | 6.8 |

The carbon content found in low char yielding prepolymers (PHDA, PHDS, PHBY) contained lower sp2 carbon content on average, ranging from 77-83%, with PHBY having the highest sp2 content. Interestingly, the sp3 content appeared to be similar to high char yielding prepolymers, ranging from 9-13%, with PHBY having the lowest sp3 content. sp2/sp3 ratios of low char yielding prepolymers were found to be lower than high char yielding prepolymers on average, with the exception of PHBY at 8.9, albeit the lowest char yielding prepolymer.

### Conclusion

The variance of thermal behavior and composition between each prepolymer gives insight into the structure-property relationship of carbon formation. Aliphatic prepolymers, PHDA and PHDS, illustrate the dramatic effect of spacing between DDA-active groups.

As spacing increases, intermolecular molecular events become dominant, decreasing the char yield, yet having slightly higher C sp2 content, suggesting a balance between intermolecular and intramolecular reactivity is essential in highly ordered carbon formation. By removing DDA-activity, the char yield is dramatically lowered as seen with PHBY, illustrating the necessity of the diyne moiety in aliphatic derivatives.

Compared to aliphatic prepolymers, PHDT is more thermally robust and produces a higher quality carbon material as seen in XPS, suggesting the presence of arene-benzyne insertion, resulting in increased thermal stability and order.

Alkynyl prepolymers, PHDBY and PBBY, give insight into the likelihood of the competitive ynedione isomerization. Thermally, both prepolymers behave similarly up until 800° C. as well with decomposition as seen in TSP-MS-IR, suggesting that the ynedione isomerization is the dominant reaction in PHDBY within this regime. Differences arise in the final carbon composition at 1000° C. as seen in XPS, suggesting that, despite being the minor product, the HDDA reaction contributes towards a more ordered carbon product.

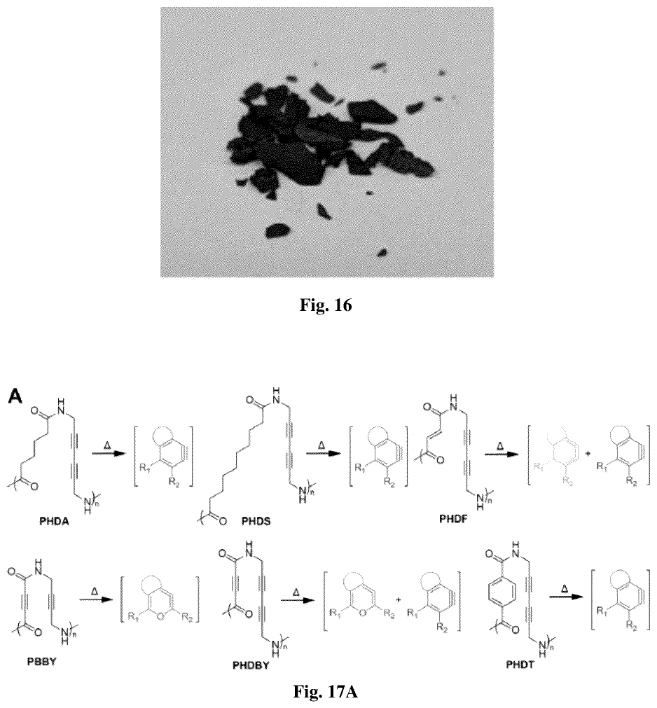

When comparing other DDA reactions, PHDF was shown to be more thermally stable up to 1000° C. (FIG. 16) However, the resulting C sp3 content was the second highest amongst the prepolymers, suggesting that the ene-diyne DDA reaction produces a slightly less ordered material due to increased sp³ defects.

### DDA-Latent Prepolymers

We have illustrated the success of the preparation, synthesis, and characterization of dehydro-Diels-Alder latent precursors. The initial DDA-latent precursors were synthesized using an interfacial polymerization method. The resulting DDA-latent precursors were shown to be thermally robust depending on their atomic composition with diyne-ene DDA precursor, PHDF, shown to be the most thermally stable, and the alkyl-tethered HDDA precursors shown to be the least thermally stable. The DDA-latent precursors underwent different modes of reactivity depending on their structure, showing a propensity for intramolecular or intermolecular reactions. Characterization of the resulting carbonaceous materials by XPS and Raman spectroscopies showed minor differences between the materials with all having an ID/IG ratio ~1.2, % C~95, % Csp2~80; however, outliers, PBBY and PHDBY, exhibited higher amorphicity due to higher intense D* and D″ bands.

### Thermal Enhancement and Flame Drip Suppression of Polyolefins

We previously described synthesis of a small library of dehydrogenative-Diels-Alder latent polyamides, which yielded sp²-rich carbonaceous materials upon heating at 1000° C. under an inert atmosphere. By using these prepolymers at low loading mixed with a polyolefin and in conjunction with thermal oxidation, we believe that reactive intermediates of the DDA-latent prepolymers can be generated that will crosslink the polyolefin and produce a more thermally robust material that can then undergo graphitization (FIG. 17A-B).

### Preparation and Stabilization of DDA-Prepolymer LDPE Mixtures

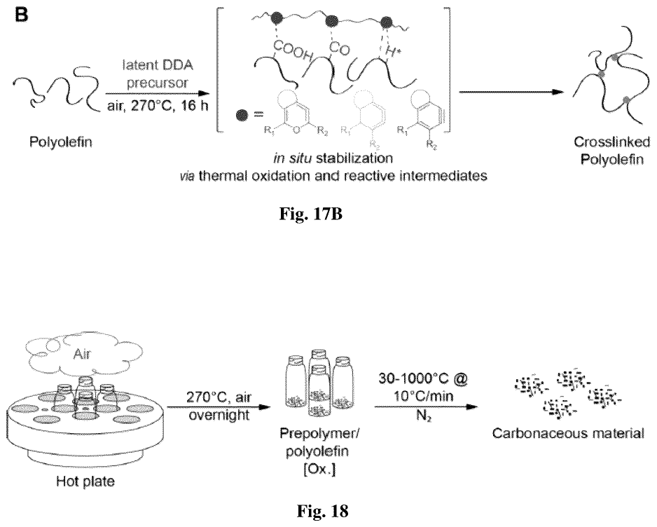

The respective polyolefin pellet, LDPE, was cooled with dry ice and ground in an electric coffee grinder for 30 s with short pulses every 1 s. The procedure was repeated until the LDPE pellets were 0.8±0.2 mm in diameter. The resulting LDPE polyolefin (18 mg) was then mixed with 10 wt. % DDA-latent prepolymers (2 mg) and thermally oxidized overnight at 270° C. on a hotplate while exposed to air (FIG. 18). This thermal oxidization is typically performed for other carbonization processes such as carbon fibers to increase thermal stability.

### FTIR Analysis of LDPE Stabilized Mixtures

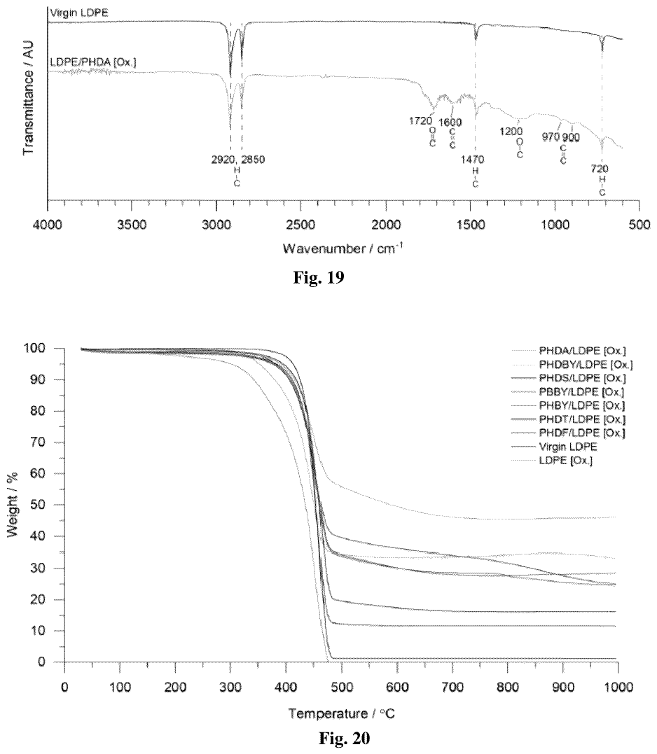

FT-IR spectra of thermally oxidized LDPE mixtures all retained the LDPE signature CH2 bands around 2920, 2850, 1465, and 720 cm⁻¹. An O—H stretch around 3400 cm⁻¹ was observed for PHTDBY, PBBY, and PHBIY mixtures. C═O stretches are observed at 1720 cm⁻¹ for all thermally oxidized mixtures, with an exception at 1700 cm-1 for PHTDBY mixture. Additionally, C—O stretches are observed for all thermally oxidized mixtures around 1200 cm. As PHDBY, PHBY, and PBBY contain O—H, C═O, and C—O stretches, it can be suggested these mixtures contain carboxylic acid or alcohol groups, including the possibility of ethers, ketones, and esters. (FIG. 19) Lesser oxidized mixtures, PHIDA, PHDS, PHTDF, and PHTDT, have evidence of ethers, ketones and esters respectively due to the lack of O—H bands. C═C aromatic stretches were observed around 1600 cm-1 for all mixtures, providing evidence of the formation of aromatic carbon.

TABLE 3
FT-IR Summary of thermally Oxidized DDA-latent Prepolymer Mixtures

| Additive | O—H/cm⁻¹ | C═O/cm⁻¹ | C═C/cm⁻¹ | C—O/cm⁻¹ | Possible Formed Species |
|---|---|---|---|---|---|
| PHDA | — | 1720 | 1600 | 1200 | Ether, ketone, ester/aromatic |
| | | | | | C═C |
| PHDS | — | 1720 | 1600 | 1210 | Ether, ketone, ester/aromatic |
| | | | | | C═C |
| PHDT | — | 1720 | 1600 | 1190 | Ether, ketone, ester/aromatic |
| | | | | | C═C |
| PHDF | — | 1720 | 1610 | 1230 | Ether, ketone, ester/aromatic |
| | | | | | C═C |
| PHDBY | 3370 | 1700 | 1630 | 1170 | Carboxylic acid, alcohol, |
| | | | | | ether, ketone, ester/aromatic |
| | | | | | C═C |
| PHBY | 3390 | 1720 | 1600 | 1170 | Carboxylic acid, alcohol, |
| | | | | | ether, ketone, ester/aromatic |
| | | | | | C═C |
| PBBY | 3380 | 1720 | 1580 | 1235 | Carboxylic acid, alcohol, |
| | | | | | ether, ketone, ester/aromatic |
| | | | | | C═C |

### Thermal Gravimetric Analysis of LDPE Stabilized Mixtures

The thermal robustness of each thermally oxidized mixture was then analyzed using thermal gravimetric analysis. ~1 mg of each dried sample was loaded in a Pt pan and underwent three separate runs heat treatment from 30-1000° C. with a heating ramp of 10° C./min under nitrogen.

Nearly all the samples underwent a significant decomposition from ~400-500° C. (FIG. 20). Surprisingly, PHDF/LDPE [Ox.] mixtures had the lowest char yield of the DDA-latent prepolymer-LDPE mixtures as untreated virgin PHDF was found to char the highest. The second highest char yielding mixture, PHDBY/LDPE [Ox.], initially was posited to form the most stable chars as has the highest potential to form thermal crosslinks, yet unexpectedly, PHDA/LDPE [Ox.] mixtures were found to have the highest char yield at 46%. As PHDS is analogous to PHDA, PHDS/LDPE [Ox.] underwent similar decomposition to form a char but at lower yield at 28%, which we attribute to the loss of additional methylene groups. The high char yield enhancement by the addition of the DDA-precursors is significant for all groups as the control of untreated virgin LDPE undergoes nearly complete decomposition from 400-500° C. Moreover, thermally oxidized LDPE control decomposed similarly and yielded no appreciable char yield.

### Raman Spectroscopy

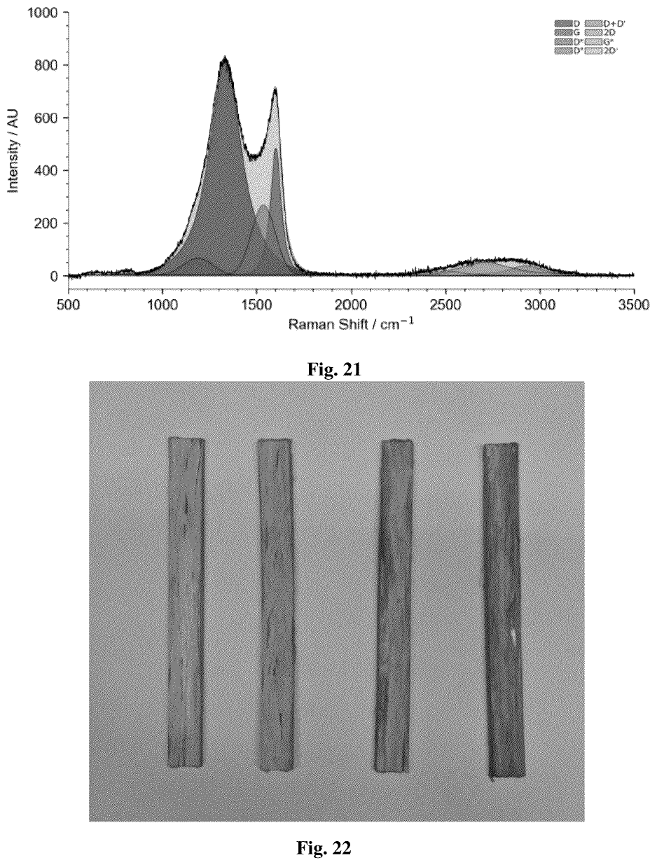

The obtained Raman spectra of PHDA/LDPE [Ox.] resulting char at 1000° C. exhibits three main features centered at 2700, 1580, and 1350 cm⁻¹, which are attributed to the G′, G, and D band. cm⁻¹ (FIG. 21) The G′ band is typically characteristic of graphitic-like materials containing sp² stacked carbons, the G band corresponds to ordered-planar sp² bonded carbon within graphitic materials, and the D band corresponds to the breathing mode of sp2 bonded carbons, causing defects within the graphitic domains.

Another band lies between the D and G peaks centered at ~1535 cm-1, D″, which has been reported for other carbon-based materials and is shown to be related to the amorphous domains of the material. A band centered ~1120 cm⁻¹ was used to interpret the broad shoulder on the D band, called D*, which has been reported to be related to the disordered graphitic lattices provided by sp²-sp³ bonds.

Comparing the intensities of the D and G band gives insight into the order of the material. With an ID/IG ratio of 1.16 and graphitic-like bands at 2700 cm⁻¹, the material is considered to be highly carbonaceous with graphitic-like order.

### Flame Drip Suppression of Polyolefins

Polyolefins are notorious for being extremely dangerous when ignited. The flaming drips formed after ignition allows fires to spread extremely rapidly, causing polyolefins to be limited in thermally demanding applications. As a result, significant effort has been put into developing viable flame retardants for polyolefins. Of the proposed methods, inherent char formation has proven to be promising as a flame retardant and has been studied extensively. The proposed flame retardancy mechanism consists of forming a continuous network of a carbon layer upon flame exposure, which acts as a flame shield and subsequently reduces the heat of combustion. This strategy has been shown promise for non-charring polymers such as PMMA, epoxies, and polystyrene by using inorganic charring agents, including NiAl, boron nitride, Cu-doped graphene, Fe₃O₄-doped sepiolite, and aluminum hypophosphite.

As PHDA/LDPE [Ox.] mixtures were found to have considerable char yield upon thermal treatment, we believe there lies potential to use a PHDA as a flame drip suppressor for polyolefins. During ignition, we believe PHDA will form a stable char, acting as a thermal shield, reducing flame drips. Furthermore, as the HDDA reaction proceeds via a diradical intermediate, we believe this also is able to act as a radical sponge, further increasing the flame retardancy.

LDPE substrates were cut into 127 mm×12.7 mm×3.2 mm pieces and were subsequently coated with PHDA during the interfacial synthesis of the nylon, where the freshly formed nylon rope was wrapped around three separate LDPE substrates to form a 0.15 mm coating (FIG. 22). Burn tests similar to UL-94V flammability test were then carried out three times in a fume hood to ensure statistically significance. Virgin LDPE and PHDA-coated LDPE samples were clamped 300 mm above dry cotton and exposed to a flame for 10 s. Upon flame exposure, virgin LDPE samples ignited and flammable drips evolved, igniting the dry cotton below. After 50 s, the flow rate of the flammable drips increased to a high flowing stream and continued to violently flow a flaming stream until the entire sample was completely burned with an average burn time of 160 s.

Upon flame exposure to PHDA-coated LDPE, flammable drips evolved, igniting the dry cotton below. After 101 s, the flow rate of the flammable drips increased to a high flowing stream, which was then shortly quenched to a slow flow of drips.

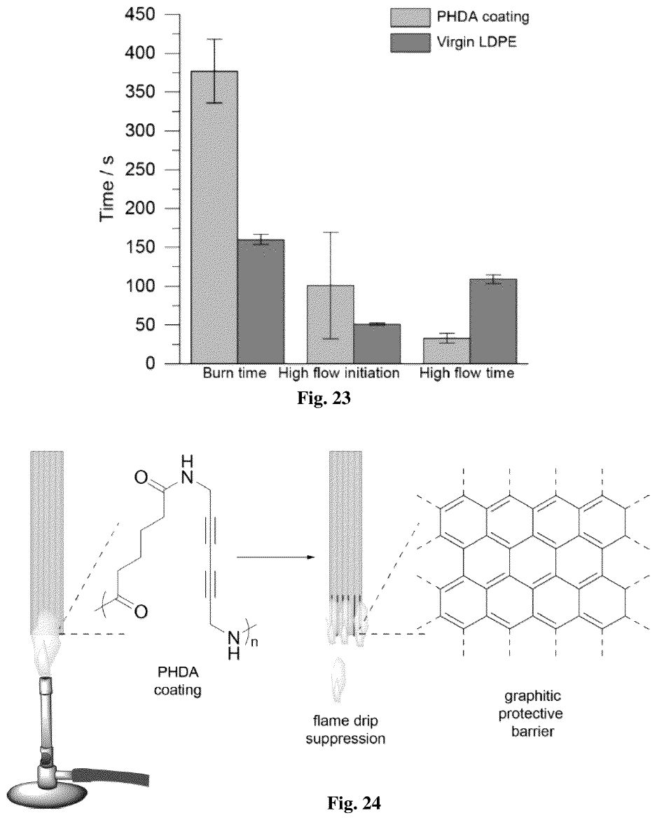

This behavior continued for 33 s of the total burn time of 377 s. Compared to uncoated samples, PHDA-coated samples took on average twice as long to initiate the high flow of flaming drips and underwent this behavior for three times less time (FIG. 23). Additionally, the average total burn time as found to be twice as long as uncoated samples.

We attribute the suppression of drips and increased burn time to the formation of stable char while ignited, making a more flame-resistant material (FIG. 24). Furthermore, we believe the HDDA reaction potentially acts as a radical sponge, further suppressing the flame drips. We believe that the flame drip suppression can be further enhanced by incorporation into polyolefins as a composite, resulting in an increase of intermolecular interactions.

### Conclusions

We have successfully prepared highly carbonaceous materials with up to 45% yield by using LDPE as a feedstock mixed with DDA-latent prepolymers charring agents coupled with thermal oxidation. Without the employment of DDA-latent prepolymers, thermally oxidized LDPE was shown to undergo nearly complete decomposition at 1000° C. We believe the added DDA-latent precursors crosslink LDPE during aerobic thermal annealing, which then produces a thermally stable carbon precursor. Examination of the resulting LDPE/PHDA [Ox.]carbons by Raman spectroscopy showed graphitic-like bands around 2700 cm-1 along with ID/IG ratio 1.16, suggesting a highly carbonaceous material.

The flame drip suppression of the best LDPE charring agent (PHDA) was then examined by subjecting PHDA-coated LDPE to UL-94V flammability tests. While not being able to completely quench the flaming drips, the overall burn behavior was significantly altered. The PHDA-coated samples took twice as long to burn while significantly reducing time undergoing high flame drippage. We believe the performance of the fire retardant can be further enhanced by mixing PHDA into an LDPE matrix, allowing the material to char continuously.

### Thermal Enhancement and Flame Drip Suppression of Polyolefins

The prepared DDA-latent prepolymers were then investigated as polyolefin charring agents coupled with thermal oxidation. Surprisingly, LDPE/PHDA [Ox.] was shown to produce the most thermally stable chars with char yields up to 45%. More surprisingly, LDPE/PHDF [Ox.] was shown to be the lowest char-yielding mixture. FT-IR analysis of the thermally LDPE/DDA-latent prepolymer mixtures were shown to contain an emergence of oxygen-functional groups such as ketones, esters, carboxylic acids, ethers, alcohols, and, most importantly, aromatic C═C. Raman spectroscopy of the resulting carbon of the highest char-yielding LDPE mixtures, PHDA/LDPE [Ox.], showed a highly ordered carbonaceous material with an ID/IG ratio of 1.16 and bands associated with graphitic-like materials around 2700 cm⁻¹.

PHDA was then examined as a potential coating for the flame drip suppression of LDPE following a UL94-V flammability test. Although unable to completely quench the flaming LDPE drippage, the behavior or the drippage was significantly impacted. The coated sample was able to double the total burn time and reduce the overall high flowing drippage by three times. We believe the flame retardancy by using DDA-latent precursors can further be enhanced by incorporation into LDPE, forming a composition.

From the above description of the invention, those skilled in the art will perceive improvements, changes and modifications. Such improvements, changes and modifications within the skill of the art are intended to be covered by the appended claims. All references, publications, and patents cited in the present application are herein incorporated by reference in their entirety.

Having described the invention, the following is claimed:

1. A method of forming a latent prepolymer with reactive groups capable of cycloadditions, the method comprising:
interfacial polymerizing a diacid chloride monomer dissolved in an organic phase with a diamine monomer dissolved in an aqueous phase to form the latent prepolymer, wherein at least one of the diacid chloride monomer or the diamine monomer includes a reactive group capable of participating in a cycloaddition reaction, and the latent prepolymer is configured to undergo a cycloaddition reaction upon thermal, photochemical, or chemical activation, or any combination these activation methods.

2. The method of claim 1, wherein a first mixture comprising the diacid chloride monomer dissolved in the organic phase and a second mixture comprising the diamine monomer and an optional auxiliary base dissolved in the aqueous phase are added together, and the latent prepolymer is formed at an interface between the first mixture and the second mixture.

3. The method of claim 1, wherein the latent prepolymer is a polyamide that includes a plurality of reactive groups capable of participating in the cycloaddition reaction.

4. The method of claim 1, wherein at least one of the diacid chloride monomer or the diamine monomer includes at least one of a monoyne, diyne, ene, or aromatic reactive group.

5. The method of claim 1, wherein the latent prepolymer is a polyamide containing at least one diyne reactive group that is configured to undergo a dehydrogenerative-Diels-Alder (DDA) reaction upon thermal, photochemical, or chemical activation, or any combination of these activation methods.

6. The method of claim 1, wherein the latent prepolymer has a char yield of at least 34% upon thermal gravimetric analysis (TGA) from 30° C. to 1000° C., with a heating ramp of 10° C./min in an inert atmosphere.

7. The method of claim 1, wherein the latent prepolymer includes at least one structure selected from: 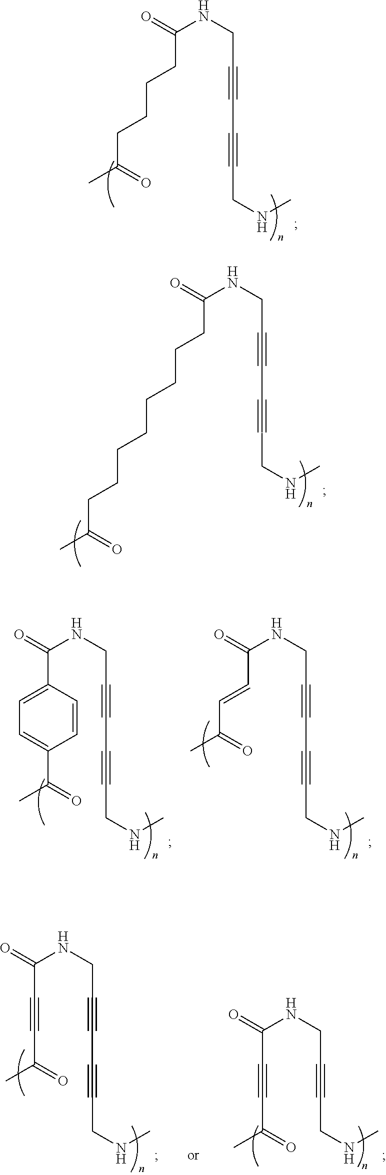
wherein n is an integer greater than 10.

8. A cycloaddition latent prepolymer formed by the method of claim 1.

9. A char-forming or flame-retardant coating or additive comprising a cycloaddition latent prepolymer of claim 8.

10. A flame-retardant polyolefin construct, comprising:
a polyolefin combined with a latent prepolymer, wherein the latent prepolymer includes at least one reactive group capable of participating in a cycloaddition reaction, and the latent prepolymer is configured to undergo a cycloaddition reaction upon thermal, photochemical, or chemical activation, or any combination of these activation methods.

11. The flame-retardant polyolefin construct of claim 10, wherein the latent prepolymer is a polyamide that includes a plurality of reactive groups capable of participating in the cycloaddition reaction.

12. The flame-retardant polyolefin construct of claim 10, wherein the latent prepolymer is formed by interfacial polymerization of a diacid chloride monomer with a diamine monomer, wherein at least one of the diacid chloride monomer or a diamine monomer includes at least one of a monoyne, diyne, ene, or aromatic reactive group.

13. The flame-retardant polyolefin construct of claim 12, wherein the latent prepolymer is a polyamide containing reactive groups that are configured to undergo a cascade dehydrogenerative-Diels-Alder (DDA) reaction upon thermal, photochemical, or chemical activation, or any combination of these activation methods.

14. The flame-retardant polyolefin construct of claim 12, wherein at least one of the diacid chloride monomer or the diamine monomer includes a diyne group, and the latent prepolymer is configured to undergo a cascade hexadehydro-Diels-Alder (HDDA) reaction upon thermal, photochemical, or chemical activation, or any combination of these activation methods.

15. The flame-retardant polyolefin construct of claim 10, wherein the latent prepolymer includes at least one structure selected from: 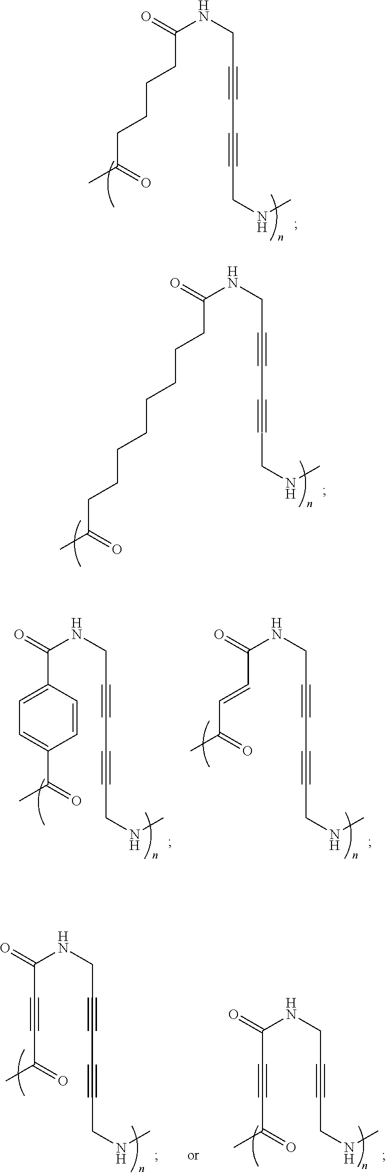
wherein n is an integer greater than 10.

16. The flame-retardant polyolefin construct of claim 10, the latent prepolymer has a char yield of at least 31% upon thermal gravimetric analysis (TGA) from 30° C. to 1000° C., with a heating ramp of 10° C./min in an inert atmosphere.

17. The flame-retardant polyolefin construct of claim 10, wherein the polyolefin comprises a low-density polyethylene, a linear low-density polyethylene, a high-density polyethylene, or polypropylene.

18. The flame-retardant polyolefin construct of claim 10, comprising a mixture or composite of the latent prepolymer and the polyolefin.

19. The flame-retardant polyolefin construct of claim 18, wherein the mixture or composite of the latent prepolymer and the polyolefin is oxidized.

20. The flame-retardant polyolefin construct of claim 10, wherein the latent prepolymer is coated on a polyolefin substrate.
